(19) United States
(12) Patent Application Publication
(10) Pub. No.: US 2025/0286189 A1
(43) Pub. Date: Sep. 11, 2025

(54) BATTERY MODULE AND BATTERY PACK WITH STRUCTURALLY INTEGRATED ARRANGEMENT FOR SIDE TERMINAL CELLS

(71) Applicant: SAMSUNG SDI CO., LTD., Yongin-si (KR)

(72) Inventor: Andreas PROELL, Helfenberg (AT)

(21) Appl. No.: 18/794,990

(22) Filed: Aug. 5, 2024

(30) Foreign Application Priority Data
Mar. 7, 2024 (EP) 24162088.9

(51) Int. Cl. H01M 50/242; B60L 50/64; H01M 10/42; H01M 10/613; H01M 10/625; H01M 10/6554; H01M 50/209; H01M 50/249; H01M 50/271; H01M 50/289; H01M 50/30; H01M 50/507; H01M 50/548

(52) U.S. Cl. CPC H01M 50/242; B60L 50/64; H01M 10/425; H01M 10/613; H01M 10/625; H01M 10/6554; H01M 50/209; H01M 50/249; H01M 50/271; H01M 50/289; H01M 50/394; H01M 50/507; H01M 50/548; H01M 2010/4271; H01M 2220/20

(57) ABSTRACT

A battery module includes: a stack of battery cells each comprising terminals at opposite ends of a hardcase; first beam having a first opening; and a first busbar. The first beam is arranged parallel to the stack direction with end pointing into and against the stack direction. The first terminal of each battery cells faces the first beam, and the first busbar electrically connects the first terminals of at least two of the battery cells and is arranged between the stack and the first beam. The first opening is aligned with a position at where the first busbar is connected to the first terminals.

### CROSS-REFERENCE TO RELATED APPLICATION

The present application claims priority to and the benefit of European Patent Application No. 24162088.9, filed on Mar. 7, 2024, in the European Patent Office, the entire disclosure of which is incorporated herein by reference.

### BACKGROUND

### 1. Field

Aspects of embodiments of the present disclosure relate to a battery module with side terminals, a battery pack including the battery module, a vehicle including the battery module, and a method for assembling the battery module.

### 2. Description of the Related Art

Recently, vehicles for transportation of goods and peoples have been developed that use electric power as a source for motion. Such an electric vehicle is an automobile that is propelled permanently or temporarily by an electric motor using energy stored in rechargeable batteries. An electric vehicle may be solely powered by batteries (a so-called Battery Electric Vehicle or BEV) or may include a combination of an electric motor and, for example, a conventional combustion engine (a so-called Plugin Hybrid Electric Vehicle or PHEV). BEVs and PHEVs use high-capacity rechargeable batteries, which are designed to provide power for propulsion for sustained periods of time.

A single battery cell includes an electrode assembly including a positive electrode, a negative electrode, and a separator interposed between the electrodes. A solid or liquid electrolyte allows for the movement of ions (e.g., lithium ions) during charging and discharging of the battery cell. The electrode assembly is located in (or accommodated in) a casing and includes electrode terminals, which are positioned on the outside of the casing, for establishing an electrically conductive connection to the electrodes. The shape of the casing may be, for example, cylindrical or rectangular.

A battery module is formed of (or includes) a plurality of battery cells coupled to each other in series or in parallel. For example, the battery module may be formed by interconnecting the electrode terminals of the plurality of battery cells in an arrangement or configuration depending on a desired amount of power and to provide a high-power rechargeable battery.

Battery modules can be constructed either in a block design or in a modular design. In the block design, each battery is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or single battery cells. The battery modules, and, respectively, the battery cells therein, may be configured in a series connection, a parallel connection, or a mixture of both to provide the desired voltage, capacity, and/or power density. Components of the battery packs include the individual battery modules and the interconnects, which provide electrical conductivity between the battery modules.

A battery system may further include a battery management system (BMS), which is any suitable electronic system that manages the rechargeable battery, battery module, and battery pack, such as by protecting the batteries from operating outside their safe operating area, monitoring their states, calculating secondary data, reporting that data, controlling its environment, authenticating it, and/or balancing it. For example, the BMS may monitor the state of the battery as represented by voltage (such as a total voltage of the battery pack or battery modules, voltages of individual cells), temperature (such as average temperature of the battery pack or battery modules, coolant intake temperature, coolant output temperature, or temperatures of individual cells), coolant flow (such as flow rate, cooling liquid pressure), and current. Additionally, a BMS may calculate values based on the above information, such as minimum and maximum cell voltage, state of charge (SOC) or depth of discharge (DOD) to indicate the charge level of the battery, state of health (SOH; a variously-defined measurement of the remaining capacity of the battery as % of the original capacity), state of power (SOP; the amount of power available for a defined time interval given the current power usage, temperature, and other conditions), state of safety (SOS), maximum charge current as a charge current limit (CCL), maximum discharge current as a discharge current limit (DCL), and internal impedance of a cell (to determine open circuit voltage).

The BMS may be centralized such that a single controller is connected to the battery cells through a multitude of wires. The BMS may be also distributed such that a BMS board is installed at each cell with only a single communication cable between (e.g., connecting between) the battery and a controller. As another example, the BMS may have a modular construction including a few controllers, each handling a certain number of (e.g., a group of) cells, with communication occurring between the controllers. Centralized BMSs are most economical but are the least expandable and are plagued by a multitude of wires. Distributed BMSs are the most expensive but are the simplest to install and offer the cleanest assembly. Modular BMSs offer a compromise of the advantages and disadvantages of the other two topologies.

A BMS may protect the battery pack from operating outside its safe operating area. Operation outside the safe operating area may be indicated by over-current, over-voltage (e.g., during charging), over-temperature, under-temperature, over-pressure, and ground fault or leakage current detection. The BMS may prevent operation outside the battery's safe operating area by including an internal switch, such as a relay or solid-state device, which is opened if the battery is operated outside its safe operating area, requesting the devices to which the battery is connected to reduce or even terminate using the battery, and actively controlling the environment, such as by using (or controlling) heaters, fans, air conditioning, or liquid cooling circuits.

The mechanical integration of such a battery pack incorporates suitable mechanical connections between the individual components, for example, of battery modules, and between them and a supporting structure of the vehicle. These connections are designed to remain functional and safe throughout the average service life of the battery system. Further, installation space and interchangeability standards must be met, especially in mobile applications.

Mechanical integration of battery modules may be achieved by providing a carrier framework and by positioning the battery modules thereon. Fixing the battery cells or battery modules may be achieved by using fitted depressions in the framework and/or by mechanical interconnectors, such as bolts or screws. In other examples, the battery modules are confined by fastening side plates to lateral sides of the carrier framework. Moreover, cover plates may be fixed atop and below the battery modules.

The carrier framework of the battery pack is mounted to a carrying structure of the vehicle. When the battery pack is fixed at the bottom of the vehicle, the mechanical connection may be established from the bottom side by, for example, bolts passing through the carrier framework of the battery pack. The framework is generally made of aluminum or an aluminum alloy to reduce the total weight of the construction.

Battery systems, according to the relate art, despite any modular structure, usually include a battery housing that acts as enclosure to seal the battery system against the environment and to provide structural protection to the battery system's components. Housed battery systems are usually mounted as a whole into their application environment, such as an electric vehicle. Thus, the replacement of defective system parts, such as a defective battery submodule, requires dismounting the entire battery system and removal of its housing first. Even defects in small and/or cheap system parts may then require dismounting and replacement of the entire battery system and its separate repair. Because high-capacity battery systems are expensive, large, and heavy, such a procedure is burdensome and the storage, such as in the mechanic's workshop, of the bulky battery systems is difficult.

Static control of battery power output and charging may not be sufficient to meet the dynamic power demands of various electrical consumers connected to the battery system. Thus, steady exchange of information between the battery system and the controllers of the electrical consumers may be implemented. This information includes the battery system's actual state of charge (SoC), potential electrical performance, charging ability, and internal resistance, as well as actual or predicted power demands or surpluses of the consumers. Therefore, battery systems usually include a battery management system (BMS) for obtaining and processing such information on a system level and further include a plurality of battery module managers (BMMs), which are part of the system's battery modules and obtain and process relevant information on a module level. The BMS usually measures the system voltage, the system current, the local temperature at different places inside the system housing, and the insulation resistance between live components and the system housing. And the BMMs usually measure the individual cell voltages and temperatures of the battery cells in a battery module.

Thus, the BMS/BMM is provided for managing the battery pack, such as by protecting the battery from operating outside its safe operating area (or safe operating parameters), monitoring its state, calculating secondary data, reporting that data, controlling its environment, authenticating it, and/or balancing it.

In case of an abnormal operation state, a battery pack may usually be disconnected from a load connected to a terminal of the battery pack. To this end, battery systems further include a battery disconnect unit (BDU) that is electrically connected between the battery module and battery system terminals. Thus, the BDU is the primary interface between the battery pack and the electrical system of the load, such as the vehicle. The BDU includes electromechanical switches that open or close high current paths between the battery pack and the electrical system. The BDU provides feedback to a battery control unit (BCU) accompanying the battery modules, such as voltage and current measurements. The BCU controls the switches in the BDU by using low current paths based on the feedback received from the BDU. The BDU may control current flow between the battery pack and the electrical system and sense current. The BDU may further manage external charging and pre-charging.

To ensure proper thermal control of the battery pack, a thermal management system may be utilized to safely use the at least one battery module by efficiently emitting, discharging, and/or dissipating heat generated from its rechargeable batteries. If the heat emission/discharge/dissipation is not sufficiently performed, temperature deviations occur between different battery cells, which may lead to the battery module not being able to generate a desired amount of power. In addition, an increase of the internal temperature can lead to abnormal reactions occurring therein and thus charging and discharging performance of the rechargeable battery deteriorates and the life-span of the rechargeable battery is shortened. Thus, cell cooling for effectively emitting/discharging/dissipating heat from the cells is desirable.

Exothermic decomposition of cell components may lead to a so-called thermal runaway. In general, thermal runaway describes a process that is accelerated by increased temperature, in turn releasing energy that further increases temperature. Thermal runaway occurs in situations where an increase in temperature changes the conditions in a way that causes a further increase in temperature, often leading to a destructive result. In rechargeable battery systems, thermal runaway is associated with strongly exothermic reactions that are accelerated by temperature rise. In thermal runaway, the battery cell temperature rises incredibly fast and the energy stored is released very suddenly. In extreme cases, thermal runaway can cause battery cells to explode and start a fire. In other cases, it can cause battery cells to be damaged beyond repair.

When a battery cell is heated above a critical temperature (e.g., above 150° C.) it can transit into a thermal runaway state. Generally, temperatures outside of the safe region on either the low or high side may lead to irreversible damage to the battery and therefore may possibly trigger thermal runaway. Thermal runaway may also occur due to an internal or external short circuit of the battery or poor battery maintenance. For example, overcharging or rapid charging may lead to thermal runaway.

During thermal runaway, the failed battery cell may reach a temperature exceeding 700° C. Further, large quantities of hot gas are ejected from inside of the failed battery cell through the venting opening of the cell housing into the battery pack. The main components of the vented gas are H₂, CO₂, CO, electrolyte vapor and other hydrocarbons. The vented gas is therefore burnable and potentially toxic. The vented gas also causes a gas-pressure to increase inside the battery pack. In the worst case scenario, the high temperatures lead to the process spreading to neighboring cells and causing a fire in the battery pack. At this stage, the fire is may be difficult to extinguish.

A battery management system (BMS) provides for the safe operation and optimal performance of secondary batteries and helps reduce or minimize the possibility of thermal runaway. For example, if the BMS detects that the temperature is too high, it can regulate the temperature by controlling cooling fans. Alternatively, if the battery or cell cannot be cooled and safe conditions restored, the BMS may shut down necessary cells to protect the entire system.

As described above, secondary batteries (e.g., Li-Ion batteries) in battery electric vehicles are mounted into specifically designed housings, in which the individual cells are electrically connected to each other. Furthermore, the housings commonly provide a thermal management for the battery cells and protect them from mechanical intrusion or damage. In the case of prismatic or pouch cells, the housing or a sub-component thereof maintains a certain compression of these cells and acts against the cells' swelling forces to prevent accelerated ageing.

In one design, multiple battery cells are arranged in modules. These act as sub-components for the battery housing, interconnect the battery cells to a certain circuitry, and carry (or absorb) swelling forces of one or more stacks of battery cells. A stack of battery cells may include multiple prismatic or pouch cells and cell spacers (or distance holders) or compression pads. In the related art, battery modules generally do not significantly contribute to the housing stiffness, which means that the housing protects the modules from mechanical abusing loadcases by carrying and transferring all external loadings.

In newer designs, one or more stacks of battery cells may be directly inserted into the battery housing, which carries the swelling forces. This design is called “cell-to-pack” or “cell-to-vehicle” and provides reduced costs as well as higher volumetric and gravimetric energy densities on a pack level but requires a more complicated assembly as well as reduced ability for later disassembly. These drawbacks are especially problematic with side terminal cells (either prismatic or pouch) in which the cell interconnecting busbars have to be applied to the stack of battery cells on two opposing sides before it is inserted into the housing.

### SUMMARY

There is a need for a battery module with a structure providing similar energy densities as the above-described cell-to-pack approaches but that provides simplified assembly, especially for side-terminal (e.g., side-pole) battery cells. Furthermore, there is a need for a battery module having a lightweight design that also provides improved load transferring capabilities. Moreover, there is a need for a battery pack including such battery modules. Also, there is a need for a method for simple assembling such a battery module.

Embodiments of present disclosure provide a battery module with a structure providing similar energy densities as cell-to-pack approaches but that provides simplified assembly, especially for side-terminal (e.g., side-pole) battery cells. Furthermore, embodiments of the present disclosure provide a battery module having a lightweight design that also exhibits improved load transferring capabilities. Moreover, embodiments of the present disclosure provide a battery pack including such battery modules. Also, embodiments of the present disclosure provide a method for simple assembling such a battery module.

The present disclosure is defined by the appended claims and their equivalents. The description that follows is subject to this limitation. Any disclosure lying outside the scope of the claims and their equivalents is intended for illustrative as well as comparative purposes.

According to an embodiment of the present disclosure, a battery module includes: a stack of battery cells, the stack including a plurality of battery cells arranged in a row along a stack direction; each of the battery cells including a hardcase having a parallelepiped shape with a pair of main sides arranged opposite to each other, a first terminal side and a second terminal side arranged opposite to each other, and a lower side and an upper side arranged opposite to each other, the main sides of each of the battery cells being arranged perpendicular to the stack direction; each of the battery cells further including a first terminal arranged on the first terminal side and a second terminal arranged on the second terminal side, the first terminal forming one electrical pole of the battery cell and the second terminal forming an opposite electrical pole of the battery cell; a first beam having one or more first openings, and a second beam having one or more second openings; at least one first busbar, and at least one second busbar. Each of the first beam and the second beam is arranged parallel to the stack direction and has a first end pointing against the stack direction and a second end pointing into the stack direction. The stack is arranged between the first beam and the second beam. The first terminal side of each of the battery cells faces the first beam, and the second terminal side of each of the battery cells faces the second beam. Each of the first busbars electrically connects the first terminals of at least two of the battery cells and is arranged between the stack and the first beam, and each of the second busbars electrically connects the second terminals of at least two of the battery cells and is arranged between the stack and the second beam. The first openings are at where the first busbar is connected to the first terminals, and the second openings are at where the second busbar is connected to the second terminals.

According to another embodiment of the present disclosure, a battery pack includes at least one battery module as described above.

Another embodiment of the present disclosure provides to a vehicle including at least one battery module described above and/or at least one battery pack described above.

Another embodiment of the present disclosure provides to a method for assembling a battery module as described above. The method includes arranging the battery cells into a stack in a stack direction such that the main sides of each battery cell are arranged perpendicular to the stack direction; attaching the first busbars to the first beam, and attaching the second busbars to the second beam; arranging the first beam along the stack such that each of the first terminal sides faces the first beam and such that the first beam is oriented such that the first busbars are each positioned between the first beam and the stack; arranging the second beam along the stack such that each of the second terminal sides faces the second beam and such that the second beam is oriented such that the second busbars are each positioned between the second beam and the stack; moving the first beam toward the stack such that the first busbars abut against the first terminals located in the area of the first busbars, and connecting the first busbars to the first terminals located in the area of the first busbars via the first openings; moving the second beam toward the stack such that the second busbars abut against the second terminals located in the area of the second busbars, and connecting the second busbars to the second terminals located in the area of the second busbars via the second openings.

Further aspects and features of the present disclosure can be learned from the dependent claims and the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1A is a perspective view of a side-pole battery cell according to an embodiment of the present disclosure.

FIG. 1B is a perspective view of a side-pole battery cell according to another embodiment of the present disclosure.

FIG. 2 is a schematic perspective view of a battery module according to an embodiment of the present disclosure.

FIG. 3 is a schematic exploded view of an assembly of a first beam and a first busbar carrier of the battery module shown in FIG. 2.

FIG. 4 schematically illustrates a partial exploded view of the battery module shown in FIG. 2.

FIG. 5 schematically illustrates a partial perspective view of the battery module shown in FIG. 2.

FIG. 6 schematically illustrates a partial perspective view of the battery module shown in FIG. 2.

FIG. 7 schematically illustrates an exploded view of the battery module shown in FIG. 2.

FIG. 8 schematically illustrates a cross-sectional view of a battery pack according to another embodiment of the present disclosure.

FIG. 9 schematically illustrates a perspective view of a battery module according to another embodiment of the present disclosure.

FIG. 10A schematically illustrates a perspective view of a first beam of the battery module shown in FIG. 9.

FIG. 10B schematically illustrates another perspective view of the first beam of the battery module shown in FIG. 9.

FIG. 11 is an enlarged view of the first beam shown in FIG. 10A.

FIG. 12 schematically illustrates a perspective view of a plurality of busbars and other components connected to busbars.

FIG. 13 schematically illustrates a perspective view of a battery pack including the battery modules shown in FIG. 9.

### DETAILED DESCRIPTION

Reference will now be made, in detail, to embodiments of the present disclosure, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Herein, the terms “upper” and “lower” are defined according to the z-axis in the drawings. For example, the upper cover is positioned at the upper part of the z-axis, and the lower cover is positioned at the lower part thereof. However, spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

As used herein, the terms “substantially,” “about,” and similar terms are used as terms of approximation and not as terms of degree and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

The electronic devices and/or any other relevant devices or components according to embodiments of the present disclosure described herein may be implemented utilizing any suitable hardware, firmware (e.g., an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements, for example, on a PCB or another kind of circuit carrier. The conducting elements may include metallization, such as surface metallization and/or pins, and/or may include conductive polymers or ceramics. Further, electrical energy may be transmitted via wireless connections, such as by using electromagnetic radiation and/or light.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random- access memory (RAM). The computer program instructions may also be stored in other non-transitory computer readable media such as, for example, a CD-ROM, flash drive, or the like.

Also, a person of skill in the art should recognize that the functionality of various computing devices may be combined or integrated into a single computing device, or the functionality of a particular computing device may be distributed across one or more other computing devices without departing from the scope of the exemplary embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to an embodiment of the present disclosure, a battery module includes: a stack of battery cells, the stack including a plurality of battery cells arranged in a row along a stack direction; each of the battery cells including a hardcase having a parallelepiped shape with a pair of main sides arranged opposite to each other, a first terminal side and a second terminal side arranged opposite to each other, and a lower side and an upper side arranged opposite to each other, the main sides of each battery cell being arranged perpendicular to the stack direction; each battery cell including a first terminal arranged on the first terminal side and a second terminal arranged on the second terminal side, the first terminal forming one electrical pole of the battery cell and the second terminal forming the opposite electrical pole of the battery cell; a first beam having one or more first openings, and a second beam having one or more second openings; one or more first busbars, and one or more second busbars. Each of the first beam and the second beam is arranged parallel to the stack direction and has a first end pointing against the stack direction and a second end pointing into the stack direction. The stack is arranged between the first beam and the second beam. The first terminal side of each battery cell faces the first beam, and the second terminal side of each battery cell faces the second beam. Each of the first busbars electrically connects, by at least two first connections, the first terminals of at least two of the battery cells and is arranged between the stack and the first beam, and each of the second busbars electrically connects, by at least two second connections, the second terminals of at least two of the battery cells and is arranged between the stack and the second beam. The first openings are aligned with respective ones of the first connections, and the second openings are aligned with respective ones of the second connections.

Accordingly, embodiments of the present disclosure provide a battery module including so-called “side-pole battery cells.” The battery module exhibits a similar energy density as cell-to-pack approaches while also providing simplified assembly. Also, the battery module includes load transferring capabilities which increases the potential for a lightweight design. The above-described battery module includes a structure that provides a similar energy density as cell-to-pack approaches while allowing for a simplified assembly, especially for side-terminal/side-pole battery cells. Furthermore, the battery module may utilize the hardcases (e.g., relatively stiff cases, barrels, or cans) of the side-terminal battery cells for further load transferring capability crossways through the battery module, which leads to significant load transferring capability in all three spatial directions. This leads to significantly increased potential for lightweight design.

One aspect of embodiments of the present disclosure may be briefly summarized as providing a structurally integrated modular assembly concept for stacks of battery cells including side-terminal battery cells.

For example, the first openings provide access to the locations at where the first connections are positioned, and the second openings provide access to the locations at where the second connections are positioned. Hence, during manufacture of the battery module and/or when repairing the battery module, the first openings as well as the second openings provide access to the locations at where the connections are to be established (or, during reparation of the battery module, loosened).

In various embodiments, some or all of the first connections and the second connections may be established by welding (e.g., by fusion-welding). Also, some or all of the first connections and the second connections may be established by screwing or clipping.

In various embodiments, some or all of the first and second connections may be covered with busbar covers that ensure sufficient creep distances.

The battery module, according to embodiments of the present disclosure, is suitable for transferring compressing loadings along the stack direction (e.g., in or against the stack direction).

The battery module, according to embodiments of the present disclosure, is suitable for transferring compressing loadings acting transverse to the stack direction and compressing (or compression) loadings acting perpendicular to the terminal sides of the battery cells when the battery cells each include a hardcase.

The battery module, according to embodiments of the present disclosure, is also configured to absorb shear forces acting in a direction transverse to the stack direction and/or in a direction transverse to the direction perpendicular to the first and second terminal sides. The shear forces may be exerted on a battery module by a battery pack's loadcases when the battery module is mounted into this battery pack by the beams as well as by the battery cells when they each include a hardcase.

In the battery module, according to embodiments of the present disclosure, the first terminal side and the second terminal side of each battery cell may be arranged perpendicular to a first transverse direction that is not parallel to the stack direction, and the lower side and the upper side of each battery cell may be arranged perpendicular to a second transverse direction that is not parallel to each of the stack direction and the first transverse direction.

In various embodiments of the battery module, the stack direction is perpendicular to the first transverse direction. In various embodiments of the battery module, the stack direction is perpendicular to the second transverse direction. In various embodiments of the battery module, the first transverse direction is perpendicular to the second transverse direction. In some embodiments of the battery module, any two of the stack directions—the first transverse direction and the second transverse direction—are perpendicular to each other. In the latter embodiment, the hardcase of each of the battery cells has a cuboid shape.

In various embodiments of the battery module, the hardcase of at least one battery cell is made of metal. In some embodiments of the battery module, the hardcase of each of the battery cells is made of metal.

In various embodiments of the battery module, for each battery cell, the (generally or substantially equally sized) main sides may be the sides having the largest areas from among the sides (e.g., the lower side, the upper side, the first terminal side, and the second terminal side) of that battery cell.

In various embodiments of the battery module, for each battery cell, the (generally or substantially equally sized) terminal sides (e.g., the first terminal side and the second terminal side) may be the sides having the smallest areas from among the sides (e.g., the main sides, the lower side, and the upper side) of that battery cell.

In some embodiments of the battery module, the first openings are located at each of the positions of the first electrical connections and/or the second openings are located at each of the positions of the second electrical connections.

The terms “lower side” and “upper side” are used the sake of intelligibility. However, without altering or departing from the above-description, the term “lower side” could be replaced by, for example, the term “first lateral side” or “first cover side,” and the term “upper side” can be replaced by, for example, the term “second lateral side” or “second cover side.”

In various embodiments, the first beam has a lower shoulder and an upper shoulder, each extending along the stack direction and being distanced to (or spaced from) each other. The lower shoulder may be connected to the upper shoulder by a plurality of struts. In such embodiments, the first openings may be formed (with regard to the stack direction) by the interstices between the struts and (with regard to a direction perpendicular to the stack direction) by the interstice between the lower and the upper shoulder.

In various embodiments, the second beam has a lower shoulder and an upper shoulder, each extending along the stack direction and being distanced to (or spaced from) each other. The lower shoulder may be connected to the upper shoulder by a plurality of struts. In such embodiments, the first openings may be formed (with regard to the stack direction) by the interstices between the struts and (with regard to a direction perpendicular to the stack direction) by the interstice between the lower and the upper shoulder.

In various embodiments, the battery module may be configured to be clamped, with regard to a direction perpendicular to the lower side and upper side of the battery cells, by using the first beam and/or the second beam.

In one embodiment, the battery module further includes a first end-plate and a second end-plate. The first end-plate is attached to the first end of the first beam and the first end of the second beam and abuts against the battery cell arranged at the first position in the row of battery cells when viewing into the stack direction. The second end-plate is attached to the second end of the first beam and the second end of the second beam and abuts against the battery cell arranged at the last position in the row of battery cells when viewing into the stack direction.

In this manner, the battery cells of the battery module can be compressed along the stack direction, with the load caused by this compression being absorbed by the beams due to the attachment (e.g., a mechanical connection) between the first and second end-plates and the first and second beams. Also, swelling forces arising from an expansion of the battery cells with respect to the stack direction (e.g., during use of the battery module or due to aging of the battery cells in the battery module) may then be transmitted, by the end-plates, to the beams and then absorbed by the beams.

In the above-described embodiments, busbar welding may be done on both terminal sides in final pre-compression state of the stack of battery cells because the beams and endplate carry the loadings.

In various embodiments of the battery module, the first end plate may include first mounting points. For example, the first mounting points may be configured for mounting the battery module into a battery pack. Correspondingly, the second end plate may include second mounting points. For example, the second mounting points may be configured for mounting the battery module into a battery pack.

In various embodiments of the battery module, the first end-plate and/or the second end-plate may include at least one pocket and/or at least one holder configured to accommodate or hold cell sensing and/or balancing boards.

In various embodiments of the battery module, the first end-plate and/or the second end-plate may be made of polymeric material.

In various embodiments of the battery module, the first end-plate and/or the second end-plate may be made of metallic material.

In one embodiment of the battery module, the electrical polarity of the first terminals alternates when viewing into the stack direction. Further, the sum of the number of the first busbars and the number of the second busbars equals (N−1), with N denoting the number of battery cells included in the battery module. When viewing into the stack direction and for each natural number k (with 1≤k<N/2), the first terminal of the (2k)-th battery cell is electrically connected, via one of the first busbars, to the first terminal of the (2k+1)-th battery cell. Also, when viewing into the stack direction and for each natural number k (with 1≤k≤N/2), the second terminal of the (2k−1)-th battery cell is electrically connected, via one of the second busbars, to the second terminal of the (2k)-th battery cell.

Because, for every battery cell, the second terminal forms a pole having an electrical polarity opposite to the electrical polarity of its first terminal, it follows that the electrical polarity of the second terminals alternates as well in the afore-mentioned embodiment when viewing into the stack direction.

For example, in such embodiment, the battery cells of the module are electrically connected in series.

In the above-described embodiment, the first terminal of the first battery cell (when viewing into the stack direction) may form the battery module's first terminal. Moreover, when the number of battery cells in the battery module is odd, the second terminal of the last battery cell (when viewing into the stack direction) may form the battery module's second terminal. In another embodiment, when the number of battery cells in the battery module is even, the first terminal of the last battery cell (when viewing into the stack direction) may form the battery module's second terminal.

In the above-described embodiment, the electrical polarity of the first terminal of the battery cell arranged first when viewing into the stack direction may be negative (and accordingly, in such an embodiment, the electrical polarity of the second terminal of the battery cell arranged first when viewing into the stack direction is positive). In another embodiment, the electrical polarity of the first terminal of the battery cell arranged first when viewing into the stack direction may be positive (and accordingly, in the latter embodiment, the electrical polarity of the second terminal of the battery cell arranged first when viewing into the stack direction is negative).

For example, when viewing into the stack direction, the first terminal of the first battery cell forms a negative electric pole, the first terminal of the second battery cell forms a positive electric pole, the first terminal of the third battery cell forms a negative electric pole, etc. Then, the positive pole of the first battery cell (e.g., the second terminal of the first battery cell) is connected to the negative pole of the second battery cell (e.g., the second terminal of the second battery cell). Further, the positive pole of the second battery cell (e.g., the first terminal of the second battery cell) is connected to the negative pole of the third battery cell (e.g., the first terminal of the third battery cell), etc.

In another embodiment of the battery module, the electrical polarity of each of the first terminals is identical (e.g., negative), and further, the electrical polarity of each of the second terminals is identical and opposite to the polarity of the first terminals. Also, in this embodiment, the battery module includes only two busbars-a single first busbar and a single second busbar. The first busbar is connected to each of the first terminals, and the second busbar is connected to each of the second terminals. For example, in such an embodiment, the battery cells are connected to each other in parallel. Here, the first busbar may form a first terminal of the battery module, and the second busbar may form a second terminal of the battery module.

In one embodiment, the battery module further includes: a first cell connect unit including a first busbar carrier holding the first busbars; and/or a second cell connect unit including a second busbar carrier holding the second busbars.

The first busbar carrier may be made of an insulating material, such as a plastic. Thus, the first busbars are electrically insulated from each other and from the first beam. Also, the insulating first busbar carrier may cover the entire first terminal side of each of the battery cells, thus, providing increased electric isolation of the battery cells to the first beam (if the latter is made of an electrical conducting material) and also providing for tolerance compensation.

In some embodiments, an insulating layer may be inserted between any one of the first busbars and the first busbar carrier.

Correspondingly, the second busbar carrier may be made of an insulating material, such as a plastic. Thus, the second busbars are electrically insulated from each other and from the second beam. Also, the insulating second busbar carrier may cover the entire second terminal side of each of the battery cells, thus, providing increased electric isolation of the battery cells to the second beam (if the latter is made of an electrical conducting material) and also providing for tolerance compensation.

In some embodiments, an insulating layer may be inserted between any one of the second busbars and the second busbar carrier.

Some or all of first busbars may be overmolded or clipped or glued into the first busbar carrier. Also, some or all of the second busbars may be overmolded or clipped or glued into the second busbar carrier.

In one embodiment, the first cell connect unit is arranged between the stack and the first beam and/or the second cell connect unit is arranged between the stack and the second beam.

In one embodiment, the battery module further includes: a first cover arranged on a side of the first beam that faces away from the stack; and/or a second cover arranged on the side of the second beam that faces away from the stack.

Hence, the first beam as well as the first busbars visible/accessible through the openings in the first beam are covered by the first cover and, thus, are protected by the first cover. Similarly, the second beam as well as the second busbars are visible/accessible through the openings in the second beam are covered by the second cover and, thus, are protected by the second cover.

In one embodiment, for at least one pair of neighboring battery cells included in the stack, a cell spacer is arranged between the battery cells of this pair.

Cell spacers (also called distance plates) may be included to improve the thermal and/or the structural (mechanical) behavior of the battery module. For example, in various embodiments, a cell spacer may be inserted into the stack after every n battery cells.

In one embodiment of the battery module, one of the cell spacers includes a module management controller.

In one embodiment, the battery module includes a first sub-module and a second sub-module. The first sub-module is separated from the second sub-module by the cell spacer including the module management controller. When viewing into the stack direction, the first sub-module includes the battery cells of the stack in front of the cell spacer including the module management controller, and the second sub-module includes the battery cells of the stack behind the cell spacer including the module management controller.

In various embodiments, the battery cells in the first sub-module are connected in series and/or the battery cells in the second sub-module are connected in series. In various embodiments, the battery cells in the first sub-module are connected in series, and the battery cells in the second sub-module are connected in parallel. In various embodiments, the battery cells in the first sub-module are connected in parallel, and the battery cells in the second sub-module are connected in series. In various embodiments, the battery cells in the first sub-module are connected in series, and/or the battery cells in the second sub-module are connected in parallel.

In one embodiment of the battery module, the battery cells are each thermally connected to at least one module cooling plate.

In various embodiments, a lower module cooling plate is provided along the lower sides of the battery cells, and each of the battery cells abuts, with its lower side, against the lower module cooling plate. Additionally or alternatively, an upper module cooling plate is provided along the upper sides of the battery cells, and each of the battery cells abuts, with its upper side, against the upper module cooling plate.

Here, the terms “lower module cooling plate” and “upper module cooling plate” are used for the sake of intelligibility. Alternatively, and without altering or departing from above-described embodiment, the term “lower module cooling plate” can be replaced by, for example, the term “first module cooling plate,” and the term “upper module cooling plate” can be replaced by, for example, the term “second module cooling plate.”

The lower module cooling plate may be glued over the entire surface formed by the lower sides of the battery cells or substantially the entire surface of the stack formed by the lower sides of the battery cells. Correspondingly, the upper module cooling plate may be glued over the entire surface of the stack formed by the upper sides of the battery cells or substantially the entire surface of the stack formed by the upper sides of the battery cells.

In one embodiment, the battery module further includes: a module venting plate provided along the lower sides of the battery cells; and a module cooling plate provided along the upper sides of the battery cells. Each of the battery cells abuts, with its lower side, against the module venting plate, and the module cooling plate is thermally connected to each of the upper sides of the battery cells.

In the above-described embodiment, the module venting plate may be glued over the entire surface of the stack formed by the lower sides of the battery cells or substantially the entire surface of the stack formed by the lower sides of the battery cells. Further, the module cooling plate may be glued over the entire surface of the stack formed by the upper sides of the battery cells or substantially the entire surface of the stack formed by the upper sides of the battery cells.

The above-described plates (e.g., the cooling plates and/or the venting plates) also provide final (mechanical) support to the battery cells included in the battery module for shock loadings. Otherwise, that is, without plates, the battery cells may be held by only the busbar welds. Hence, in the above-described embodiments, including at least one plate (e.g., at least one of the cooling plates and/or venting plates), the shock resistance of the battery module is improved in comparison to a bare module without plates.

According to another embodiment of the present disclosure, a battery pack includes at least one battery module as described above.

Embodiments of the battery pack may include at least one pack cooling plate. For example, one or more module cooling plates of the battery modules included in the battery pack may be formed by respective portions of the pack cooling plate.

For example, the battery pack may include a lower pack cooling plate. Then, at least some of the lower module cooling plates of at least some of the battery modules may be formed as part of the lower pack cooling plate. Alternatively or additionally, the battery pack may include an upper pack cooling plate. Then, at least some of the upper module cooling plates of at least some of the battery modules may be formed as part of the upper pack cooling plate.

Embodiments of the battery pack may include at least one pack venting plate. For example, one or more module venting plates of the battery modules included in the battery pack may be formed by respective portions of the pack venting plate.

In some embodiments, the battery pack further includes a battery pack housing configured to accommodate at least one battery module as described above. The battery pack housing may include a load bearing structure, and the at least one battery module may form a part of the load bearing structure.

In embodiments of the battery pack, the first beams of at least some of the battery modules may act as stiffening ribs for the housing of the battery pack. Alternatively or additionally, the second beams of at least some of the battery modules may act as stiffening ribs for the housing of the battery pack.

In various embodiments of the battery pack, at least some of the battery modules included in the battery pack are mounted and/or fixed to the housing of the battery pack via at least one of their respective end-plates. Each battery module included in the battery pack is mounted and/or fixed to the housing of the battery pack via at least one, and in some embodiments, each, of its end-plates.

For example, at least some of the battery modules are fixed to the (remaining) load bearing structure of the battery pack housing via at least one their respective end-plates.

In various embodiments of the battery pack, the load bearing structure includes shoulders or cross-braces, at least some of the cross-braces being configured for transmitting compression forces onto the beams of the battery modules.

Another embodiment of the present disclosure provides a vehicle including at least one battery module as described above and/or at least one battery pack as described above. The vehicle may be a hybrid vehicle or a fully electric vehicle.

Another embodiment of the present disclosure provides a method for assembling a battery module as described above. The method includes providing a first beam having one or more first openings, a second beam having one or more second openings, one or more first busbars, one or more second busbars, and a plurality of battery cells, each of the battery cells including a hardcase having a parallelepiped shape with a pair of main sides arranged opposite to each other, a first terminal side and a second terminal side arranged opposite to each other, and a lower side and an upper side arranged opposite to each other. Each battery cell includes a first terminal arranged on the first terminal side and a second terminal arranged on the second terminal side. The method further includes arranging the battery cells into a stack directed into a stack direction such that the main sides of each battery cell are arranged perpendicular to the stack direction; attaching the first busbars to the first beam, and attaching the second busbars to the second beam; arranging the first beam along the stack such that each of the first terminal sides faces the first beam and such that the first beam is oriented such that the first busbars are each positioned between the first beam and the stack; arranging the second beam along the stack such that each of the second terminal sides faces the second beam and such that the second beam is oriented such that the second busbars are each positioned between the second beam and the stack; moving the first beam toward the stack such that the first busbars abut against the first terminals located in the area of the first busbars, and connecting the first busbars to the first terminals located in the area of the first busbars through the first openings; moving the second beam toward the stack such that the second busbars abut against the second terminals located in the area of the second busbars, and connecting the second busbars to the second terminals located in the area of the second busbars through the second openings.

In various embodiments, the method may further include providing at least one cell spacer. In such embodiments, the method may include arranging the cell spacers at positions between ones of the battery cells with regard to the stack direction.

The method may further include properly aligning the battery cells and holding the battery cells in place by a suitable clamping device.

The method may further include pre-compressing the stack of battery cells with regard to the stack direction. When the stack further includes cell spacers, the method may include pre-compressing the assembly of stacked of battery cells and cell spacers with regard to the stack direction.

In various embodiments of the method, the method may further include providing a first busbar carrier. In such embodiments, the method may include fixing the first busbars to the first busbar carrier and attaching the first busbar carrier (with the fixated busbars) to the first beam.

In various embodiments, the method may further include providing a second busbar carrier. In such embodiments, the method may include fixing the second busbars to the second busbar carrier, and attaching the second busbar carrier (with the fixated busbars) to the second beam.

In some embodiments of the method, the connection of the first busbars to the first terminals is performed by welding, and/or the connection of the second busbars to the second terminals is performed by welding.

In an embodiment, the method may further include providing a first end-plate and a second end-plate, arranging the first end-plate in front of the first battery cell when viewing into the stack direction, and arranging the second end-plate behind the last battery cell when viewing into the stack direction;

The method may include pre-compressing the assembly of stacked battery cells and the first and second end-plates with regard to the stack direction and compressing or increasing the pre-compression of the assembly of stacked of battery cells and the first and second end-plates with regard to the stack direction such that each of the first and second end-plates comes into touch with the first and the second beam. The method may include fixing each of the first and second end-plate to each of the first and second beam.

In various embodiments of the method, the fixing of the end-plates to the beams may be performed by using bolts, screwing, or welding.

Accordingly, embodiments of the method may include one or more of the following steps:

The battery cells, cell spacers, end-plates, and in some cases, distance plates are arranged together and pre-compressed.

The beams with busbar carriers are attached from the sides.

Compression on the end-plates is further increased to enforce touch- condition between beams and end-plates.

Beams and end-plates are joined together (e.g., by bolting, welding, etc.)

The battery cells are aligned (because they may be just clamped from one side up to this step) and held in place with an appropriate clamping device.

Busbars are welded from the outside through the openings in the beams on both sides.

If not implemented into the busbar carrier, cell sensing and other sensors may be attached onto the busbars.

Busbar covers may be applied to increase creep distances for electric components.

The battery module may be inserted into the outer housing structure and attached to a cooling plate and/or a venting plate with adhesive and/or a gap filler material (e.g., thermal interface material).

The battery module may be joined to the housing with further connections (e.g., bolts, pins, welding, etc.) for increased structural integrity.

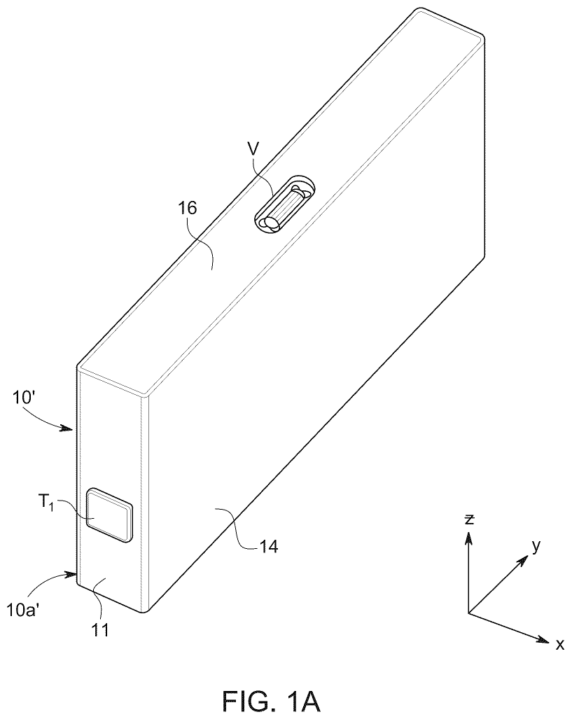

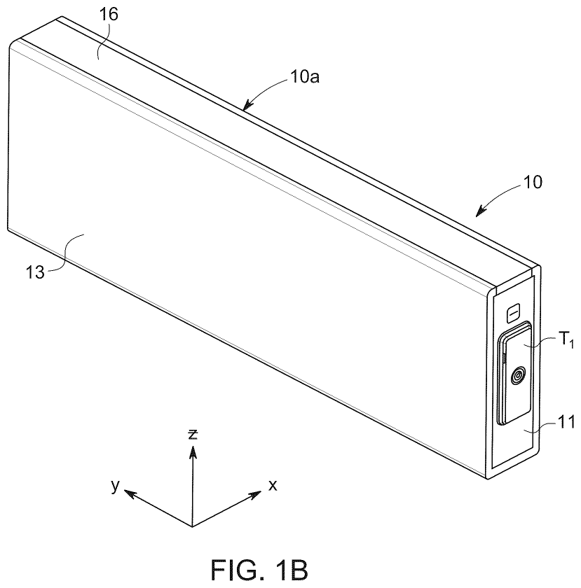

FIG. 1A is a perspective view of a side-pole battery cell 10′ according to an embodiment of present disclosure that can be used in, for example, a battery module for an electric or hybrid vehicle. A Cartesian coordinate system with x, y, and z axes is depicted in FIG. 1A. As shown in FIG. 1A, the battery cell 10′ has a parallelepiped (e.g., prismatic) shape. The case 10a′ is a hardcase, which may be made of a metal material. The case 10a′ may be a can or barrel having six planar outer side faces. The case 10a′ has a pair of congruent main sides (of that pair, only the side 14 facing into the x-direction is visible in FIG. 1A) arranged opposite to each other, each of the main sides being perpendicular to the x-axis. Also, the case 10a′ has a lower side (not visible in FIG. 1A) and an upper side 16, the lower side and the upper side 16 being congruent, arranged opposite to each other, and perpendicular to the z-axis. Finally, the case 10a′ has a pair of congruent lateral sides (of this pair, only the side 11 facing against the y-direction is visible in FIG. 1A) arranged opposite to each other.

The pair of congruent lateral sides includes a first lateral side 11 facing against the y-direction and a second lateral side (not visible in FIG. 1A) facing into the y-direction. A first terminal T₁ is arranged on the first lateral side 11 of the case 10ₐ′. Similarly, a second terminal T₂ (not visible in FIG. 1A) is arranged on the second lateral side. Hence, throughout the present disclosure, the first lateral side 11 may be referred to as the “first terminal side,” and the opposite second lateral side may be referred to as the “second terminal side.” The terminals T₁, T₂ allow for an electrical connection with the battery cell 10′. The first terminal T₁ may be the negative terminal (e.g., the negative pole) of the battery cell 10′, and the second terminal T₂ may be the positive terminal (e.g., the positive pole) of the battery cell 10′. In this battery cell format, the main sides (e.g., the side 14 and the opposite side) have the largest areas from among the side faces of the case 10a′, and the terminal sides (e.g., the lateral sides) have the smallest areas from among the side faces of the case 10a′.

A venting outlet V is arranged on (or in) the upper side 16 of the case 10a′. Accordingly, the upper side 16 may be referred to as the “venting side” of the battery cell 10′ or of the case 10a′. Vent gas can be ejected from the battery cell 10′ through the venting outlet V in the case of a thermal event occurring within the battery cell 10′, such as a thermal runaway. Inside the battery cell 10′, a valve (not shown in FIG. 1A) may be installed in (e.g., may be installed at an upstream position of) the venting outlet V, and the valve may be configured to open (or burst) when the gas pressure inside the battery cell 10′ exceeds a reference (or predefined) value and may be configured to remain in a closed state otherwise, that is, when the gas pressure inside the battery cell 10′ is below the reference value. Thus, before being emitted via the venting outlet V, the vent gas may pass through the venting valve arranged inside the battery cell 10′.

In some embodiments of the side-pole battery cell 10′, the second terminal T₂ may have a shape that is identical to the shape of, but mirrored with respect to, the first terminal T₁, the mirroring taken with respect to the x-z-plane of the coordinate system. For example, each of the first terminal T₁ and the second terminal T₂ has a flat shape extending along a region of a plane parallel to the x-z-plane. The first terminal T₁ and/or the second terminal T₂ may have, when viewed along the y-direction, a rectangular shape, such as a square shape. In other embodiments, the second terminal T₂ may have a shape different from the shape of the first terminal T₁.

In some embodiments of the side-pole battery cell 10′, the battery cell 10′ has an outer appearance that is symmetrical with regard to mirroring the battery cell 10′ on a first virtual plane parallel to the x-z-plane of the coordinate system (with the first virtual plane being positioned, with regard to the y-direction, in the center between the first terminal side 11 and the second terminal side). Also, the outer appearance of the battery cell 10′ may be symmetrical with regard to mirroring the battery cell 10′ on a second virtual plane parallel to the y-z-plane (with the second virtual plane being positioned, with regard to the x-direction, in the center between the pair of first lateral sides), and/or may be symmetrical, except for the ventilation hole V, with regard to mirroring the battery cell 10′ on a third virtual plane parallel to the x-y-plane (with the third virtual plane being positioned, with regard to the z-direction, in the center between the pair of second lateral sides).

FIG. 1B illustrates a perspective view of a side-pole battery cell 10 according to another embodiment of the present disclosure that may be used in, for example, a battery module for an electric or hybrid vehicle. The structure of the battery cell 10 is similar to that of the battery cell 10′ shown in FIG. 1A. The battery cell 10 includes a case 10a, which is a hardcase made of, for example, a metal material. However, in comparison to the battery cell 10′ shown in FIG. 1A, the battery cell 10 shown in FIG. 1B has a more elongated shape, that is, the ratio of the extension (or length) along the y-axis to the extension (or width) along the z-axis is larger. Further, the venting outlet is arranged on the lower side of the battery cell 10 and, thus, is not visible in FIG. 1B.

The battery cell 10′ shown in FIG. 1A and the battery cell 10 shown in FIG. 1B are embodiments of side-pole battery cells that may be used in battery modules according to embodiments of the present disclosure, which will be described below.

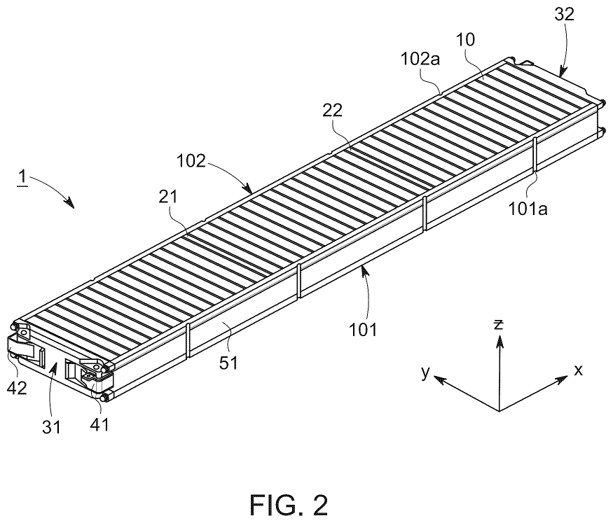

FIG. 2 is a schematic perspective view of a battery module 1 according to an embodiment of the present disclosure. A Cartesian coordinate system with x, y, and z axes is included to facilitate the following description. The battery module 1 is illustrated as being a large-format module for longitudinal configuration in an electric vehicle (EV) in its fully assembled state, but the present disclosure is not limited thereto. The illustrated battery module 1 includes a stack of 45 side-pole battery cells 10, each having a parallelepiped shape. For example, the battery cells 10 may each correspond to the battery cell 10 shown in FIG. 1B. With regard to the coordinate system, the battery cells 10 are stacked along (e.g., are adjacent to each other in) the x-direction, which will be referred to as the “stack direction” hereinafter. Cell spacers 21, 22 (also called “distance plates”) may be inserted between some or each pair of adjacent battery cells 10. The cell spacers 21, 22 may be inserted behind every battery cell 10 to improve thermal and structural behavior. In the illustrated embodiment, the cell spacers are inserted into the stack after every 15 battery cells 10.

In the stack, the side-pole battery cells 10 are each orientated such that their respective main sides (not visible in FIG. 2) are arranged orthogonal to the x-direction, that is, are perpendicular to the stack direction. Further, their respective terminal sides (not visible in FIG. 2) are arranged perpendicular to the y-direction such that the first terminal side faces into the y-direction and the second terminal side faces against the y-direction. Also, the battery cells 10 are electrically connected to each other by a plurality of busbars (not visible in FIG. 2) attached to their terminals. This will be explained in more detail below.

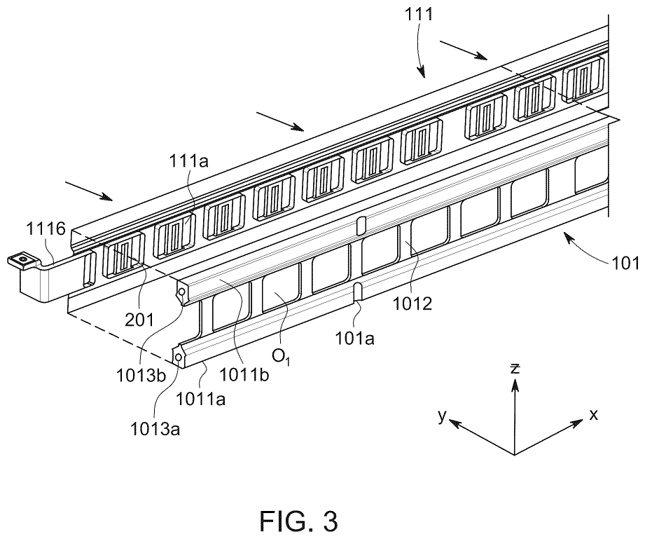

The battery module 1 further includes a first beam 101 and a second beam 102. Each of the beams 101, 102 has a longitudinal shape oriented along the x-direction and is attached to the stack. The first beam 101 extends along the first terminal sides of each of the battery cells 10, and the second beam 102 extends along the second terminal sides of each of the battery cells 10. The first beam 101 and the second beam 102 are each configured to provide structural rigidity to the battery module 1. For example, the beams 101, 102 may be made of a metal material. To ease the process of connecting the busbars to the terminals of the battery cells, each of the beams 101, 102 may have a plurality of openings O₁, O₂ (see, e.g., FIG. 3). This will be explained in more detail below with reference to FIG. 3.

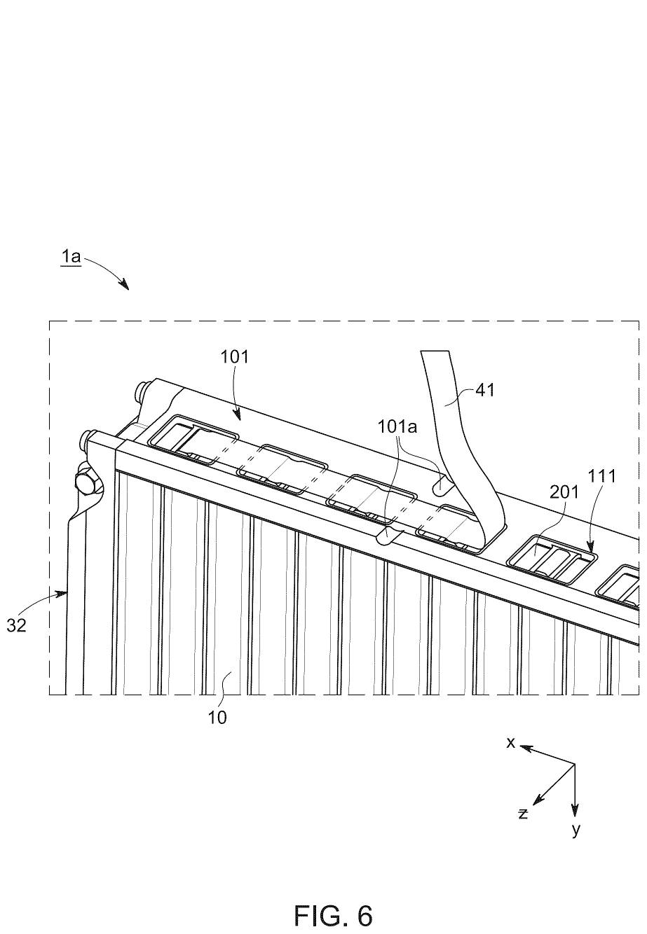

The first beam 101 has a plurality of first recesses 101a to facilitate fixation (e.g., clamping) of the battery module 1 within a battery pack. For example, each of the recesses 101a is formed as a semi-circular indentation provided in the first beam 101 (see also, e.g., FIGS. 3 and 6). The second beam 102 has a plurality of similar second recesses 102a for the same reason.

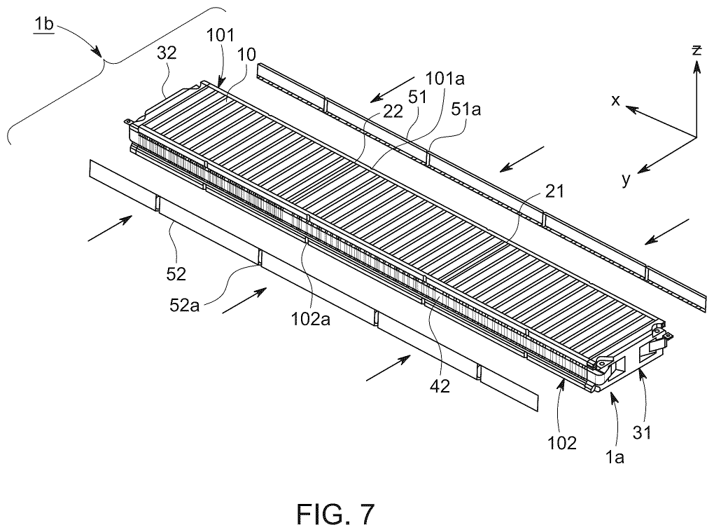

A first busbar carrier 111 (not visible in FIG. 2; see, e.g., FIG. 3) is arranged between the first terminal sides of the battery cells 10 and the first beam 101. Similarly, a second busbar carrier (not visible in FIG. 2) is arranged between the second terminal sides of the battery cells 10 and the second beam 102. The first and second busbar carriers 111, 112 each has a longitudinal shape orientated along the x-direction. As will be explained in more detail below with reference to FIG. 3, the busbar carriers 111, 112 are configured for carrying (e.g., supporting or fixing) the busbars. One or more sensors are arranged on the busbars. The sensors are integrated or attached to tapes 41, 42 (see, e.g., FIG. 6) that can be easily implemented into the battery module 1. Other electric and/or electronic components may also be embedded into these tapes 41, 42. Busbar covers 51, 52 (see, e.g., FIG. 7) can be attached to the beams 101, 102 to protect the busbars and to increase the creep distance of the electronic components integrated or attached to the tapes 41, 42. This will be explained in more detail below with reference to FIG. 7.

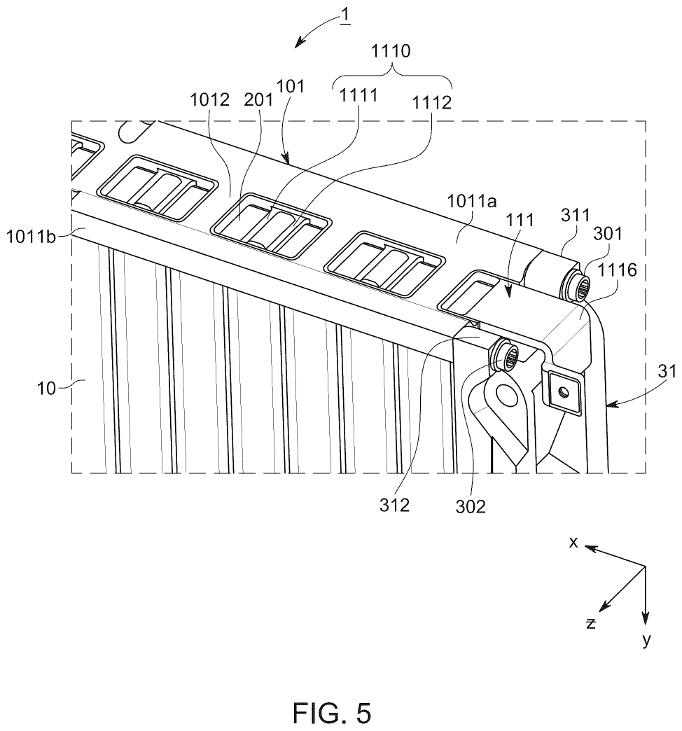

Multifunctional end-plates 31, 32 (see, e.g., FIG. 5) are joined to the ends of the beams 101, 102. A first end-plate 31 is joined to ends of the first and second beams 101, 102 pointing against the x-direction, and a second end-plate 32 is joined to opposing ends of the first and second beams 101, 102 pointing into the x-direction. The joining of the end-plates 31, 32 to the beams 101, 102 may be provided by bolting, screwing, welding, or similar fastening techniques. This will be described in more detail below with reference to FIG. 5.

FIG. 3 schematically illustrates an exploded view of an assembly of the first beam 101 and the first busbar carrier 111 shown in FIG. 2. As shown in FIG. 3, the first beam 101 has a pair of shoulders, that is, a lower shoulder 1011a and an upper shoulder 1011b, each of which extends parallel to the x-axis of the coordinate system. The lower shoulder 1011a and the upper shoulder 1011b are connected to each other by a plurality of struts 1012 periodically (e.g., repeatedly) arranged along the x-direction, ends of each of which extend along the z-direction. Due to this arrangement, the opening O₁ is formed between any two struts neighboring in the x-direction, and confined, in the z-direction, by the lower shoulder 1011a and the upper shoulder 1011b. Accordingly, the first beam 101 has the plurality of first openings O₁ providing access to a plurality of first busbars 201 (only one of which is labeled with a reference sign for the sake of simplicity of the drawing) held in position behind the first beam 101 (when viewing into the y-direction) by the first busbar carrier 111.

As already described above with reference to FIG. 2, the first busbar carrier 111 is configured to be placed between the first terminal sides of the battery cells 10 of the battery module 1 and the first beam 101. Hence, in the assembled state of the battery module 1, the first busbar carrier 111 abuts against the first beam 101, which is indicated in FIG. 3 by the arrows pointing against the y-direction. During manufacture, the busbar carrier 111 with the busbars 201 placed therein is pre-assembled, before the assembly of the battery module 1 is started. The first busbar carrier 111 has a plurality of cut-outs 111a located at the positions that are intended to be placed on (e.g., that will be aligned with) the first terminals of the battery cells 10 when the battery module 1 is assembled (see, e.g., FIG. 2). Hence, during manufacture, when the first busbar carrier 111 and the first beam 101 are arranged or aligned accordingly besides the first terminal sides of the battery cells 10 (as shown in, for example, FIG. 2), the busbars 201 can be (at least partly) accessed from outside through the first openings O₁ in the first beam 101 and one or more cut-outs 111a located behind the first openings O₁ (when viewing into the y-direction), thus allowing for joining of the first busbars 201 to respective first terminals arranged behind the first busbars 201 (when again viewing into the y-direction; the first terminals are not visible in FIGS. 2 and 3).

Accordingly, due to the afore-described access to the busbars 201 provided by the first openings O₁ in the first beam 101 and the cut-outs 111a in the first busbar carrier 111, the first busbars 201 can be joined (e.g., welded) to respective first terminals arranged behind the first busbars 201 (when viewing into the y-direction) by welding tools (e.g., a welding torch or blowpipe) reaching the welding areas of the busbars 201 through the first openings O₁ in the first beam 101 and the cut-outs 111a in the first busbar carrier 111.

The first busbars 201 may be attached to the first busbar carrier 111 by, for example, over-molding, clipping, or gluing. Further, the first busbar carrier 111 may be fixed to the first beam 101 by, for example, clipping or gluing.

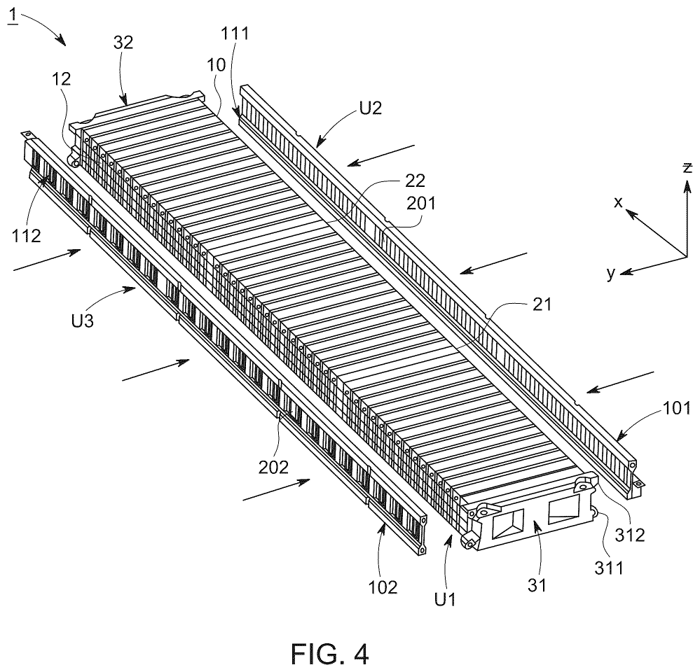

The arrangement and assembly of the second beam 102 (see, e.g., FIG. 4), the second busbar carrier 112, and a plurality of second busbars 202 is similar as described above with respect to the first beam 101, the first busbar carrier 111, and the plurality of first busbars 201, with the only difference being that the shape and arrangement of the members is mirrored with regard to a virtual plane parallel to the x-z-plane of the coordinate system.

To electrically isolate the busbars 201, 202 from the beams 101, 102, which are made of a metal material and, thus, are electrically conductive, the busbar carriers 111, 112 are each made of an isolating material, such as a plastic.

FIG. 4 schematically illustrates a partial exploded view of the battery module 1 shown FIG. 2 with the busbar covers 51, 52 omitted. The view of FIG. 4 may be interpreted as one state of the assembly during manufacture of the battery module 1. In the illustrated state, the battery module 1 includes three pre-assembled units U1, U2, U3. The first pre-assembled unit U1 is the stack including a plurality of battery cells 10 and cells spacers 21, 22 arranged in a row along the x-direction, the stack being confined (with regard to the x-direction) by a pair of the first and second end-plates 31, 32, as described above. The second pre-assembled unit U2 includes the first beam 101 being already attached to the first busbar carrier 111 carrying the plurality of first busbars 201. The third pre-assembled unit U3 includes the second beam 102 being already attached to the second busbar carrier 112 carrying the plurality of second busbars 202.

With the afore-described three pre-assembled units U1, U2, U3 being present, the further assembly of the battery module 1 as shown in FIG. 1 is rather simple, as follows. The first pre-assembled unit U1 is pushed to the first terminal sides of the battery cells 10 (as indicated by the arrows pointing into the y-direction) such that the side of the first unit U1 facing into the y-direction abuts against the first terminal sides of all of the battery cells 10. Similarly, the second pre-assembled unit U2 becomes pushed to the second terminal sides 12 of the battery cells 10 (as indicated by the arrows pointing against the y-direction) such that the side of the first unit U2 facing against the y-direction abuts against the second terminal sides 12 of all of the battery cells 10. Then, by a suitable connecting tool (e.g., a welding torch/blowpipe) guided through the first openings O₁ in the first beam 111 and the cut-outs 111a in the first busbar carrier 111 to welding areas of the first busbars 201, the first busbars 201 are fixed to first terminals of the battery cells 10. Similarly, by the suitable connecting tool guided through the second openings O₂ in the second beam 102 and the cut-outs 112a in the second busbar carrier 112 to welding areas of the first busbars 202, the second busbars 202 are fixed to second terminals of the battery cells 10. Finally, the first end-plates 31 is fixed (e.g., by using screws; see, e.g., FIG. 5) to the end of the first beam 101 pointing against the x-direction as well as to the end of the second beam 102 pointing against the x-direction, and similarly, the second end-plates 32 are fixed (e.g., by using screws; see, e.g., FIGS. 5 and 6) to the end of the first beam 101 pointing into the x-direction as well as to the end of the second beam 102 pointing into the x-direction. During the afore-described process of assembling the three units U1, U2, and U3, the individual battery cells 10 may be held in place by clamps (e.g., to avoid slippage of the battery cells 10 along the z-direction), and/or the first unit U1 (e.g., the stack of battery cells 10 and cells spacers 21, 22 together with the first and second end-plates 31, 32) may be compressed in the x-direction.

FIG. 5 schematically illustrates a partial perspective view of the battery module 1 shown in FIG. 2 without the tape 41 and the busbar cover 51 to provide a detailed view of the connection between the first end-plate 31 and the first beam 101. The spatial arrangement of the stacked battery cells 10, the first end-plates 31, the first beam 101, the first busbar carrier 111, and the first busbars 201 with respect to each other has already been described above with reference to, for example, FIGS. 2 to 4. As shown in FIG. 5, the first end-plates 31 are fixated (e.g., fixed) to the first beam 101 by using first and second bolts (or screws) 301, 302. For example, the first bolt (or screw) 301 is inserted through a through-hole provided in a first protrusion 311 of the first end-plate 31 into a first bore-hole 1013a provided in the respective end of the lower shoulder 1011a of the first beam 101 (see also, e.g., FIG. 3). Correspondingly, the second bolt (or screw) 302 is inserted through a through-hole provided in a second protrusion 312 of the first end-plate 31 into a second bore-hole 1013b provided in the respective end of the upper shoulder 1011b of the first beam 101 (see also, e.g., FIG. 3).

It is understood that similar fixations may also be provided in a corresponding manner between the first end-plate 31 and the second beam 102, as well as between the second end-plate 32 and the first beam 101 (see, e.g., FIG. 6), and as well as between the second end-plate 32 and the second beam 102.

The afore-described fixations between the end-plates 31, 32 and the beams 101, 102 provide a sufficiently robust mechanical connection such that swelling forces caused by swelling of the battery cells 10 acting against the x-direction onto the first end-plate 31 and into the x-direction onto the second end-plate 32 can be absorbed by the end-plates 31, 32 and redirected to the beams 101, 102 through the connections described above. Also, due to the rigidity of the first and second beams 101, 102, the swelling forces are absorbed by the first and second beams 101, 102.

FIG. 5 illustrates one example fixation, by which each of the first busbars 201 is carried (e.g., is held in position) by the first busbar carrier 111. For each busbar 201, a plurality of struts extending along the z-direction may be provided by the first busbar carrier 111, and the struts are configured such that the respective busbar 201 can be clamped between these struts. As shown in FIG. 5, the plurality of struts is a pair of the first strut 1111 and the second strut 1112. Between the first strut 1111 and the second strut 1112, a third strut (not visible in FIG. 5 because it is covered by one of the busbars 201) is provided. Then, the busbar 201 can be clamped between the first strut 1111 and the second strut 1112 on the one side of the busbar 201 and the third strut on the other side of the bus bar 201. It is understood that a similar clamping mechanism may also be employed to attach the second busbars 202 to the second busbar carrier 112.

The first busbar carrier 111 may be extended (or prolonged) against the x-direction by a snatch 1116, into which the first end-plate 31 can be clamped. This may be useful to hold the first end-plate 31 in place during manufacture, before the end-plate 31 is fixated to the beams 101, 102 by, for example, using bolts and/or screws, as described above. It is understood that the first busbar carrier 111 may also prolonged similarly into the x-direction to hold the second end-plate 32 in place, and that the second busbar carrier 112 may be equipped or configured correspondingly.

FIG. 6 schematically illustrates a partial perspective view of the battery module 1 shown in FIG. 2 without the busbar cover 51 and showing an area of the corner at where the second end-plate 32 is attached to the first beam 101. As already described with FIG. 2, the battery module 1 includes one or more battery cell sensors (e. g., temperature sensors) and other sensors (e. g., voltage sensors, current sensors) that are attached on the first busbars 201. In the illustrated embodiment, the sensors are integrated in or attached to a first tape 41 fixable onto the busbars 201 in a position (e.g., a predefined position). In the drawing, the tape 41 is shown in a state of being only partially fixed to the first beam 101. For example, the first tape 41 may be formed as an adhesive tape that may be glued onto the outer side (e.g., the side facing away from the stack) of the first beam 101. Then, through the openings O₁ in the first beam 101 as well as the cut-outs 111a in the first busbar carrier 111, the first tape 41 contacts parts of the busbars 201. Hence, by providing the sensors at respective positions, the sensors integrated in or attached to the first tape 41 can be connected (e.g., electrically and/or thermally connected) to the busbars 201 at the desired (or predefined) positions. The first tape 41 may include signal lines for transmitting the signals generated by the sensors to a controller, such as a module management controller (MMC). The first tape 41 may include further electric or electronic components, for example, control units. It is understood that a corresponding second tape 42 (not shown in FIG. 6) may be provided and which is configured to be attached on the outer side of the second beam 102 and having further sensors to be connected to the second busbars 202 (see, e.g., FIG. 7).

FIG. 7 schematically illustrates an exploded view of the battery module 1 shown in FIG. 2. As shown in FIG. 7, the busbar covers 51, 52 are shown in a state of being detached from the body of the battery module 1. As described above, the battery module 1 includes the first tape 41 with sensors being connected to the first busbars 201 (not visible in FIG. 7) and, correspondingly, a second tape 42 with sensors being connected to the second busbars 202. To increase the creep distances for these sensors (and, in various embodiments, further electric and/or electronic components integrated in or attached on the first and second tapes 41, 42) and to protect these sensors and components from external mechanical loads, busbar covers 51, 52 can be attached to the beams 101, 102. The busbar covers 51, 52 also protect the busbars 201, 202 from external mechanical, electrical, or thermal impacts, which otherwise may influence the busbars 201, 202 through the tapes 41, 41 via the openings O₁, O₂ in the beams 101, 102 and the cut-outs in the busbar carriers 111, 112.

A first busbar cover 51 may have a ]-shaped cross-sectional profile (with regard to a cross-section parallel to the y-z-plane of the coordinate system and when viewing into the x-direction) and is attached to the side of the first beam 101 that faces away from the stack of battery cells 10 and cells spacers 21, 22. This is shown in FIG. 7 by the arrows besides the first busbar cover 51 pointing into the y-direction. Also, a second busbar cover 52 may have a [-shape cross-sectional profile (with regard to a cross-section parallel to the y-z-plane and when viewing into the x-direction) and is attached to the side of the second beam 102 that faces away from the stack of battery cells 10 and cells spacers 21, 22. This is shown in FIG. 7 by the arrows besides the second busbar cover 52 pointing against the y-direction.

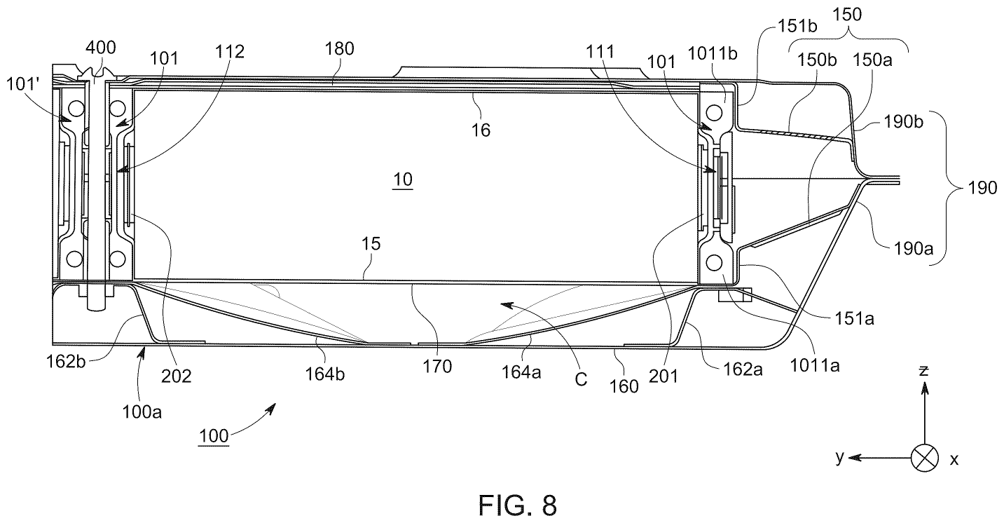

At positions that are configured to be located on the first recesses 101a of the first beam 101, the first busbar cover 51 includes slots or spaces 51a, which provide access to the recesses 101a when the busbar cover 51 is attached to the first beam 101. In this manner, brackets or bolts 400 (see, e.g., FIG. 8) can be brought in engagement with the recesses 101a even when the first beam is covered by the first busbar cover 51. For a similar reason, the second busbar cover 52 includes corresponding slots or spaces 51b at positions that are configured to be located on the second recesses 102a of the second beam 102.

In other embodiments, the first and second tapes 41, 42 with the sensors and, in some embodiments, other electric and/or electronic components, may be omitted. In such embodiments, the first busbar cover 51 only protects the first busbars 201 from outer influences/impacts, and the second busbar cover 52 only protects the second busbars 202 from outer influences/impacts. Also, in various embodiments, only one of the first busbar cover 51 and the second busbar cover 52 may be used. This applies to both embodiments including the first tape 41 and/or the second tape 42 as well as to embodiments omitting the tapes 41, 42.

FIG. 8 is a schematic cross-sectional view of a battery pack 100 according to another embodiment of the present disclosure. In the illustrated embodiment, the battery pack 100 includes a housing 100a accommodating a plurality of battery modules 1 as described before with reference to FIGS. 2 to 7 arranged in a row along the y-direction. Only a portion of the battery pack 100 is illustrated in FIG. 8. Specifically, only the rightmost battery module (with regard to the view provided by FIG. 8) is completely shown, which includes a battery cell 10, a first beam 101, and a second beam 102. Also, the first beam 101′ of a neighboring battery module 1 is visible.

The plurality of battery modules 1 is accommodated in the housing 100a of the battery pack 100. The housing 100a includes a bottom plate 160, a venting plate 170, and a cooling plate 180, each of which extend parallel to the x-y-plane of the coordinate system, which is provided in the drawing to facilitate the following description. The venting plate 170 is arranged a distance (e.g., a certain distance) above the bottom plate 160. The venting plate 170 is supported by a plurality of support braces 162a, 162b resting on the bottom plate 160. A pair of support braces, that is, a first support brace 162a and a second support brace 162b, is mounted, beneath each of the battery modules 1 accommodated in the housing 100. According to this arrangement, beneath any one of the battery modules 1, a channel C extending along the x-direction is formed. The channel C is confined, with respect to the y-direction, by the first and second support braces 162a, 162b and, with respect to the z-direction, by the bottom plate 160 and the venting plate 170. The housing 100 further includes a pair of lateral plates confining the housing 100 with regard to the y-direction. In FIG. 8, only a right lateral plate 190 is shown, which has a lower portion 190a and an upper portion 190b.

Each of the battery modules 1 is placed on top of the venting plate 170. Hence, each of the battery module's 1 battery cells 10 abuts, with its lower side 15, against the venting plate 170. The venting plate 170 may have a plurality of cut-outs located, with respect to the x-and y-directions, at the positions of (e.g., aligned with) venting outlets provided in the lower side of the battery cells 10 (see, e.g., FIGS. 1A and 1B). These cut-outs are located, with respect to the z-direction, beneath the venting outlets of the battery cells 10. Hence, vent gas and/or other materials exhausted or ejected from the venting outlets in case of a thermal event enter the channel C through the afore-mentioned cut-outs in the venting plate 170. Moreover, the venting plate 170 provides mechanical support to the battery modules (and its components, such as the individual battery cells 10, cell spacers, etc.) arranged thereon, in particular with regard to the z-direction. Cross-braces 164a, 164b may also be provided in the interstice between the bottom plate 160 and the venting plate 172 to further increase the housing's 100a mechanical stability against shear forces acting parallel to the y-z-plane of the coordinate system on the housing 100a. In the cross-sectional view illustrated in FIG. 8, the cross-braces 164a, 164b are each arranged in a diagonal direction, with regard to the y-axes and the z-axes of the coordinate system, between the bottom plate 160 and the venting plate 170 within the area of the channel C.

The cooling plate 180 is arranged on top of the plurality of battery modules 1 such that the upper sides 16 of any one of the battery cells 10 is in thermal contact with the cooling plate 180. In the embodiment illustrated in FIG. 8, the upper sides 16 of the battery cells 10 each abut, from beneath, against the lower surface of the cooling plate 180. The cooling plate 180 may be thermally connected to a cooling system, which is configured to actively cool the cooling plate 180 during operation of the battery pack 100. The cooling plate 180 provides mechanical support to the battery modules (and its components, such as the individual battery cells 10, cell spacers, etc.) arranged thereunder, in particular, with regard to the z-direction.

The individual battery modules 1 may be further held in place by one or more brackets 400, which may engage with respective recesses 101a, 102a (see, e.g., FIGS. 2, 3, and 6) provided in the first and second beam 101, 102 of each battery module 1. Each of the brackets 400 may be configured to be placed in between two neighboring battery modules 1 with regard to the y-direction, as shown in FIG. 8. In such an embodiment, the brackets 400 may each have a symmetric shape such that they allow placement and/or clamping of each of the two neighboring battery modules 1. As illustrated in FIG. 8, both the second beam 102 of the rightmost battery module 1 as well as the first beam 101′ of the further battery module 1 arranged next to the rightmost battery module 1 to the left are held at the same time by one of the brackets 400. In various embodiments, the brackets 400 may be formed as bolts configured to be (at least partially) inserted into the semi-circular recesses 101a, 102a provided in the first and second beams 101, 102 and described above with reference to, for example, FIGS. 2, 3, and 6.

As can be further seen in FIG. 8, the rightmost battery module 1 is held in place, with regard to the y-direction, at its right side directly by the housing 100a of the battery pack 100. For example, the rightmost battery module 1 abuts, with its first beam 101, against the vertical portions 151a, 151b of supporting struts 150a, 150b resting on the battery pack's 1 right lateral side 190. For example, the lower shoulder 1011a of the first beam 101 (see also, e.g., FIG. 3) is supported by a lower portion 151a of the lower supporting strut 150a resting on the lower portion 190a of the battery pack's 1 right lateral plate 190. Correspondingly, the upper shoulder 1011b of the first beam 101 (see also, e.g., FIG. 3) is supported by an upper portion 151b of the upper supporting strut 150b resting on the upper portion 190a of the battery pack's 1 right lateral plate 190. Hence, loads applied from the outside to the right lateral plate 190 are transferred, by the lower and upper supporting struts 150a, 150b, directly to the shoulders 1011a, 1011b of the first beam 101, which, in turn, transfers the load to the cases 10a of the individual battery cells 10 included in the rightmost battery module 1. From there, the load may be similarly transferred by the subsequently arranged battery modules 1 into the y-direction. It is understood that a similar structure may also be present on the opposite side of the battery pack 100, for example, between a leftmost lateral plate of the battery pack 100 and the leftmost battery module 1 arranged in the battery pack 100.

Thus, provided that the cases 10a of the individual battery cells 10 each exhibit sufficient stability, the battery modules 1 themselves contribute to the stiffness—and, thus, to the mechanical stability—of the housing 100a of the battery pack 100. Thus, the cases 10a of the individual battery cells 10 are each formed as a hardcase made by a suitable material, such as metal or a metal alloy.

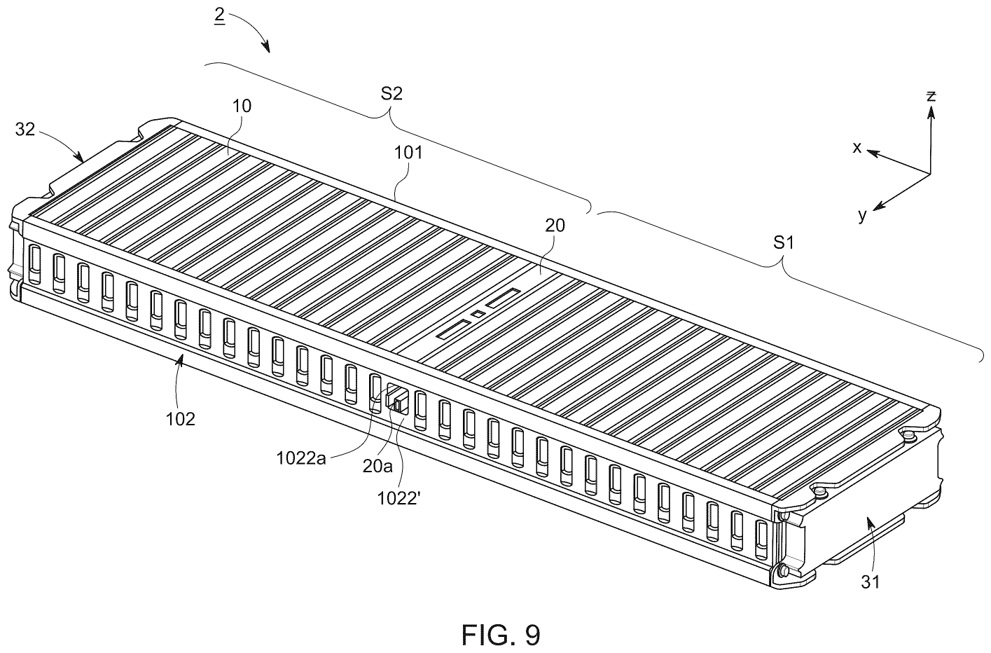

The battery module 1 illustrated in FIG. 2 is able to transfer compressive loadings transverse to cell stacking direction (e.g., the y-direction in FIG. 2) by transferring them through the cases 10a of the individual battery cells 10; therefore, loadings should be introduced to the upper and lower shoulder of the beams (see, e.g., FIG. 8). The battery module 1 is further able to be clamped in a z-direction near the beams with bolting joints or similar (see semicircular recesses in, for example, FIGS. 6 and 8). Also, the battery module 1 is configured to absorb shear forces acting parallel to the x-z-plane and/or the y-z-plane, which occur during the battery pack's 100 bending loadcases. However, these properties are also provided by another embodiment of a battery module according to the present disclosure, which will be described below with reference to FIGS. 9 to 13.

FIG. 9 schematically illustrates a perspective view of a battery module according to another embodiment of the present disclosure. Similar to the battery module 1 described above with reference to FIGS. 2 to 7, the battery module 2 illustrated in FIG. 9 includes a stack of battery cells 10 arranged along the x-direction, and at certain positions between two neighboring battery cells 10, a cell spacer 20 is inserted. The stack is confined, at its ends, by a first end-plate 31 and a second end-plate 32, similar to the embodiment described above with reference to FIG. 2. In the embodiment shown in FIG. 9, the cell spacer 20 is inserted in a center position of the stack (with respect to the x-direction), thus dividing the stack of battery cells 10 into two equally sized sub-stacks, with a first sub-stack including the battery cells arranged between the first end-plate 31 and the cell spacer 20 and a second sub-stack including the battery cells between the cell spacer 20 and the second end-plate 31.

However, different from the embodiment described above with reference to FIGS. 2 to 7, the battery cells 10 are not electrically interconnected to each other to form a single circuit, for example, in a series connection of the battery cells 10 or a parallel connection of the battery cells 10 included in the stack. Instead, the battery cells 10 in the first sub-stack are interconnected to each other to form a first circuit, and the battery cells 10 in the second sub-stack are interconnected to each other to form a second circuit. The first circuit and the second circuit are not (at least not directly) electrically connected to each other. For example, the battery cells 10 in the first sub-stack form a first sub-module S1, and the battery cells 10 in the second sub-stack form a second sub-module S2.

However, despite being electrically separated, the first sub-module S1 and the second sub-module S2 share common structural elements. For example, a first beam 101 and a second beam 102 are arranged at the lateral sides (e.g., the sides facing into and against the y-direction) of the overall stack, thus, providing lateral support to both the battery cells 10 in the first sub-stack/first sub-module S1 and the battery cells 10 in the second sub-stack/second sub-module S2 as well as to the cell spacer 20. Also, a first busbar carrier and a second busbar carrier are each shared by either sub-stack/sub-module S1, S2.

In the embodiment shown in FIG. 9, the cell spacer 20 includes a module management controller (MMC) integrated in the cell spacer 20. The MMC is configured to receive signals generated by the sensors arranged in the battery module 2. The MMC may be further configured to evaluate the signals and to control processes having an influence on the battery module 2, for example, thermal control such as cooling or limiting the electric load, etc. The MMC may be connected to a BMS or BMU of a battery pack or a battery system including the battery module 2 shown in FIG. 9.

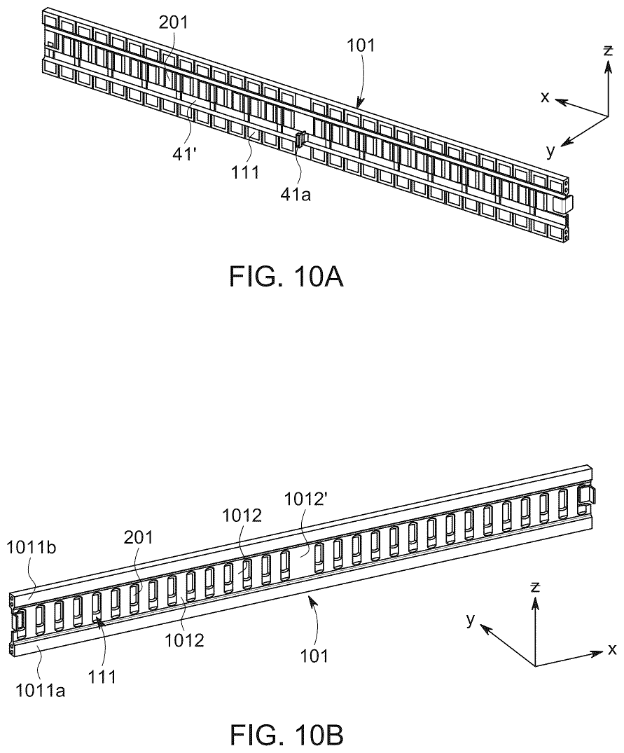

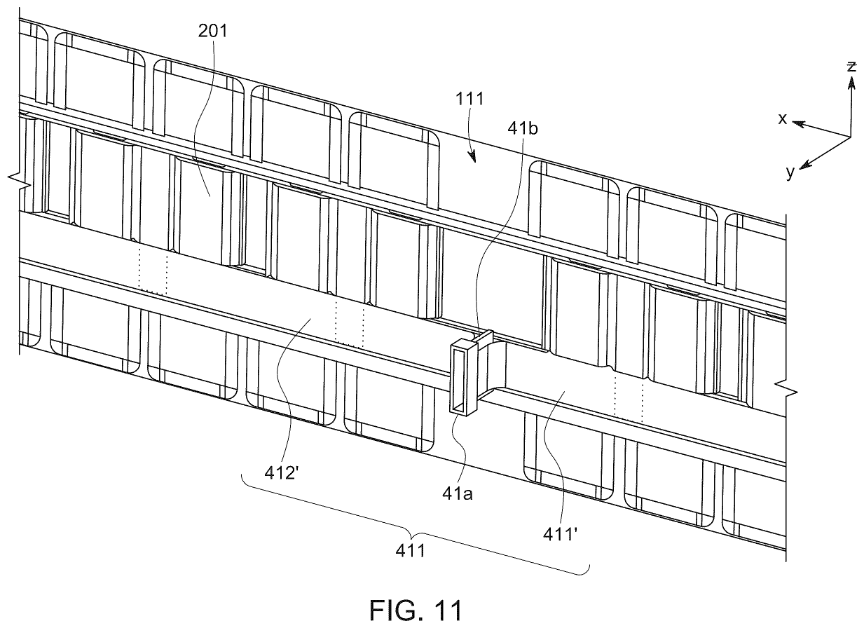

FIG. 10A schematically illustrates a perspective view of a first beam 101 of the battery module 2 shown in FIG. 9 into which the first busbar carrier 111 is implemented. The first busbar carrier 111 carries (or accommodates) a plurality of busbars 201 similar to the busbar carrier described above with respect to FIG. 3. The side of the busbar carrier 111 visible in FIG. 10A is configured to be attached to the battery cell stack. As can be seen in FIG. 10A, the cell sensing devices (integrated in a band or tape 41′) are implemented into the busbar carrier 111, different from the embodiment depicted in FIG. 6. The band 41′ may also include other electric or electronical components, such as signal lines, etc. At a center position with regard to the x-direction, a band connector 41a is installed on the band 41′, which is configured for establishing a connection of the signal lines to the module management controller (MMC) in the cell spacer 20 when the battery module 2 shown in FIG. 9 is assembled. It is understood that the second beam 102 together with the second carrier 112 (as well as the second busbars 202 and, possibly, further cell sensing devices) may have a similar structure (see, e.g., FIG. 9).

FIG. 10B schematically illustrates another perspective view of the first beam 101 of the battery module 2 shown in FIG. 9, in which the busbar carrier 111 is attached (from behind with respect to the view of FIG. 10B) to the first beam 101. The first beam 101 has a structure substantially similar to the structure of the beam depicted in FIG. 3 in that it has a lower shoulder 1011a and an upper shoulder 1011b, each extending along the x-direction and connected to each other by a plurality of struts 1012 arranged between the shoulders 1011a, 1011b leaving openings in the first beam, through which the first busbars 201 are accessible. At a center position with regard to the x-direction, for example, at the position vis-à-vis to the cell spacer 20 (including the MMC) in the assembled battery module 2 shown in FIG. 9, a strut 1012′ is formed that is thicker (with regard to the x-direction) in comparison to the remaining struts 1012 to cover the MMC 20 at its lateral side facing to the first beam 101. It is understood that the second beam 102 together with the second carrier 112 (as well as the second busbars 202 and, possibly, further cell sensing devices) may have a similar structure, with the exception, however, that the thicker center strut 1022′ includes a cut-out 1022a allowing one or more connectors 20a (that may be collected in a plug), such as one or more high-voltage (HV) connectors to be passed through the cut-out 1022a (see, e.g., FIG. 9).

FIG. 11 is an enlarged view of the first beam 101 shown in FIG. 10A showing the area around the band connector 41a. As can be seen in FIG. 11, a protrusion 41b protrudes from the first busbar carrier 111. The band connector 41a, which is formed as a plug, is positioned on the protrusion 41b. The band 41′ includes a first sub-band 411′ and a second sub-band 412′ electrically isolated from each other. The first sub-band 411′ abuts against the busbars 201 configured to be connected to the battery cells of the first sub-module S1 (see, e.g., FIG. 9). Correspondingly, the second sub-band 412′ abuts against the busbars 201 configured to be connected to the battery cells of the second sub-module S2 (see, e.g., FIG. 9). Hence, by connecting the band connector 41a to the MMC, the MMC is enabled to receive signals from sensors (integrated in or arranged on the band 41′) measuring states of the battery cells of the first sub-module S1 as well as states of the battery cells of the second sub-module S2.

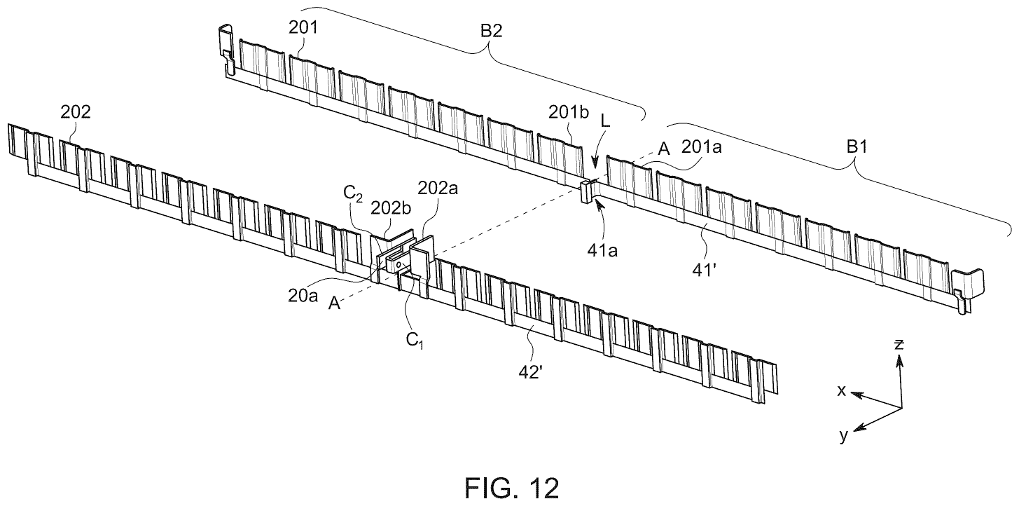

FIG. 12 schematically illustrates a perspective view of a skeleton structure of a plurality of busbars 201, 202 and other components 41′,42′ connected to the busbars 201, 202. The skeleton includes the plurality of first busbars 201, the plurality of second busbars 202, the first band 41′, a corresponding second band 42′ connected to the second busbars 202, the band connector 41a, and the connector 20a. Here, the connector 20 is configured as a high-voltage (HV) connector. As can be seen in FIG. 12, the individual first busbars 201 (aligned subsequently parallel to the x-axis of the coordinate system) are separated from each other by interstices. Correspondingly, the individual second busbars 202 (aligned subsequently parallel to the x-axis of the coordinate system) are also separated from each other by interstices. Further, the plurality of first busbars 201 is arranged opposite, with respect to the y-direction, to the plurality of second busbars 202. However, with respect to the x-direction, the plurality of second busbars 202 is shifted by a distance (e.g., a certain distance) relative to the plurality of first busbars 201 such that each of the individual of busbars 201 is arranged opposite, with respect to the y-direction, to an interstice between a pair of second busbars 202. However, in the center of the depicted arrangement with regard to the x-direction (indicated by the dashed line A-A), the interstices between the neighboring first busbars 201 as well as between the neighboring second busbars 202 are enlarged. Hence, when inserting battery cells 10 between the plurality of first busbars 201 and the plurality of second busbars 202 (thereby each of the battery cells 10 being orientated such as shown in FIG. 9), the arrangement of the first and second busbars 201, 202 provides a series connection of the battery cells 10 arranged in the first region B1 with respect to the x-direction (e.g., of the first sub-stack of battery cells 10 as described above with reference to FIG. 9), thereby forming the first sub-module S1 of the battery module 2 illustrated in FIG. 9. At the same time, the arrangement of the first and second busbars 201, 202 provides a series connection of the battery cells 10 arranged in the second region B2 with respect to the x-direction (e.g., of the second sub-stack of battery cells 10 as described above with reference to FIG. 9), thereby forming the second sub-module S2 of the battery module 2 illustrated in FIG. 9.

Further, the HV connector 20a includes a first connector plate C₁ electrically connected to the busbar 202a (included in or from among the plurality of second busbars 202) being arranged in the first region B1 next to the center position marked by the dashed line A-A, and a second connector plate C₂ electrically connected to the busbar 202b (included in or from among the plurality of second busbars 202) being arranged in the second region B2 next to the center position marked by the dashed line A-A. These connector plates C₁, C₂ protrude into the y-direction and are configured to protrude through the cut-out 1022a in the second beam 102, as already described above with reference to FIGS. 9 and 11. On the other hand, between the pair of first busbars 201a, 201b arranged next to the center position marked by the dashed line A-A, an enlarged interstice L is provided that is configured to receive the connector plates C₁, C₂ from another entity of the battery module 2 shown in FIG. 9.

In this manner, the connector plates C₁, C₂ provide high-voltage paths for both sub-modules S1, S2, which enables a module-to-module connection (e.g., between two entities of the battery module 2 shown in FIG. 9) by simple rotation, relative to each other, of two entities of the battery module 2 to be connected, or by simply plunging these two entities of the battery modules 2 together. Then, after having connected a first entity of the battery module 2 to a second entity of the battery module 2, the connector plate C₁ establishes an electrical connection between the center second busbar 202a of the first sub-module S1 of first entity with the center first busbar 201a of the first sub-module S1 of the second entity. Correspondingly, the connector plate C₂ establishes an electrical connection between the center second busbar 202b of the second sub-module S2 of first entity with the center first busbar 201b of the second sub-module S2 of the second entity.

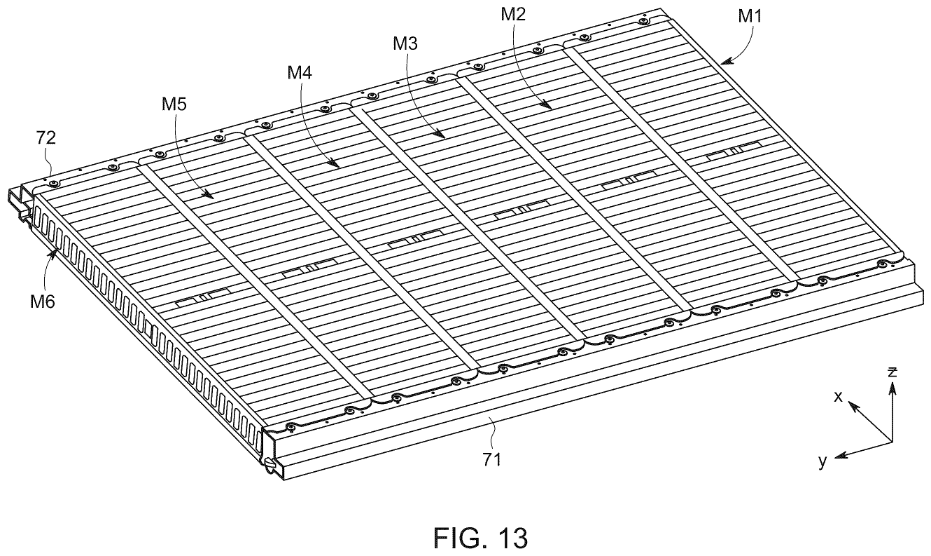

Hence, the above-described assembly of the battery module 2 shown in FIG. 9 allows for a rather simple and fast assembly of a battery pack 200 as illustrated in FIG. 13, which includes six battery modules M1 to M6 according to the embodiment depicted in FIG. 9. While assembling the battery pack 200 shown in FIG. 13, one may start with the rightmost first battery module M1 (with regard to view provided by the drawing). Then, the second battery module M2 (in the order corresponding to the y-direction) can be attached to the first battery module M1 and electrically connected to the latter in the manner as described above with reference to FIG. 12. Correspondingly, the third battery module M3 is attached and electrically connected to the second battery module M2. The remaining battery modules M4, M5, and M6 are implemented similarly. Subsequently, a first protection element 71 is attached to the first end-plates 31 of the battery modules M1 to M6, the first end-plates 31 facing against the x-direction (see, e.g., FIG. 9). A second protection element 71 is attached to the second end-plates 32 of the battery modules M1 to M6, the second end-plates 32 facing into the x-direction (see, e.g., FIG. 9). The first and second protection elements 71, 72 each extend parallel to the y-direction along the entire extension of the battery pack 200 with regard to the y-direction, thereby each forming a longitudinal crash absorbing structure protecting the battery modules M1 to M6 from outer impacts, in particular, from shock loads.

### SOME REFERENCE SYMBOLS

1, 2 battery module
10, 10′ battery cell
10a, 10a′ hardcase
11 first lateral side/first terminal side
12 second lateral side/second terminal side
13, 14 main sides
15 lower side
16 upper side
20 cell spacer including module management controller (MMC)
20a connectors
21,22 cell spacers
31,32 end-plates
41, 42 tapes
41′ band
41a band connector
41b protrusion
51, 51 busbar covers
71, 72 protection elements
100 battery pack
101, 101′ first beam
101a first recesses
102 second beam
102a second recesses
111 first busbar carrier
112 second busbar carrier
150a, 150b supporting struts
151a, 151b vertical portions of supporting struts
160 bottom plate
162a, 162b support braces
164a, 164b cross-braces
170 venting plate
180 cooling plate
190 lateral plate
190a lower portion of lateral plate
190b upper portion of lateral plate
201 first busbar(s)
301 first bolt or screw
302 second bolt or screw
311 first protrusion of first end-plate
312 second protrusion of first end-plate
400 bracket or bolt
1011a, 1011b shoulders
1012 struts
1012′ thick strut
1013a, 1013b bore-holes
1116 snatch
1022′ thick strut
1022a cut-out
A-A dashed line
B1, B2 regions
C₁, C₂ connector plates
M1, M2, M3, M4, M5, M6 battery modules
O₁ first openings
O₂ second openings
S1, S2 sub-modules
U1, U2, U3 pre-assembled units
V venting outlet
x, y, z axes of a Cartesian coordinate system

What is claimed is:

1. A battery module comprising:
a stack of battery cells, the stack comprising a plurality of battery cells arranged in a row along a stack direction; each of the battery cells comprising a hardcase having a parallelepiped shape with a pair of main sides arranged opposite to each other, a first terminal side and a second terminal side arranged opposite to each other, and a lower side and an upper side arranged opposite to each other, each of the battery cells further comprising a first terminal arranged on the first terminal side and a second terminal arranged on the second terminal side, the first terminal forming one electrical pole of the battery cell, and the second terminal forming an opposite electrical pole of the battery cell;
a first beam having a first opening;
a second beam having a second opening;
a first busbar; and
a second busbar,
wherein each of the first beam and the second beam is arranged parallel to the stack direction and has a first end pointing against the stack direction and a second end pointing into the stack direction,
wherein the stack is arranged between the first beam and the second beam,
wherein the first terminal side of each of the battery cells faces the first beam, and the second terminal side of each of the battery cells faces the second beam,
wherein the first busbar electrically connects the first terminals of at least two of the battery cells and is arranged between the stack and the first beam, and the second busbar electrically connects the second terminals of at least two of the battery cells and is arranged between the stack and the second beam, and
wherein the first opening is aligned with a position at where the first busbar is connected to the first terminals, and the second opening is aligned with a position at where the second busbar is connected to the second terminals.

2. The battery module as claimed in claim 1, further comprising a first end-plate and a second end-plate,
wherein the first end-plate is attached to the first end of the first beam and the first end of the second beam and abuts against the battery cell arranged at a first position in the row of battery cells when viewing into the stack direction, and
wherein the second end-plate is attached to the second end of the first beam and the second end of the second beam and abuts against the battery cell arranged at a last position in the row of battery cells when viewing into the stack direction.

3. The battery module as claimed in claim 1, wherein the electrical polarity of the first terminals alternates along the row of battery cells when viewing into the stack direction,
wherein a sum of a number of the first busbars and a number of the second busbars equals N−1, with N denoting a number of the battery cells,
wherein, when viewing into the stack direction and for each natural number k with 1≤k<N/2, the first terminal of the (2k)-th battery cell is electrically connected, via one of the first busbars, to the first terminal of the (2k+1)-th battery cell, and
wherein, when viewing into the stack direction and for each natural number k with 1≤k≤N/2, the second terminal of the (2k-1)-th battery cell is electrically connected, via one of the second busbars, to the second terminal of the (2k)-th battery cell.

4. The battery module as claimed in claim 1, the battery module further comprising:
a first cell connect unit comprising a first busbar carrier holding the first busbar; and
a second cell connect unit comprising a second busbar carrier holding the second busbar.

5. The battery module as claimed in claim 4, wherein the first cell connect unit is arranged between the stack and the first beam, and
wherein the second cell connect unit is arranged between the stack and the second beam.

6. The battery module as claimed in claim 1, further comprising:
a first cover arranged on a side of the first beam facing away from the stack; and
a second cover arranged on a side of the second beam facing away from the stack.

7. The battery module as claimed in claim 1, further comprising a cell spacer arranged between a neighboring pair of the battery cells.

8. The battery module as claimed in claim 7, wherein the cell spacer comprises a module management controller.

9. The battery module as claimed in claim 8, further comprising a first sub-module and a second sub-module,
wherein the first sub-module is separated from the second sub-module by the cell spacer, and
wherein, when viewing into the stack direction, the first sub-module comprises the battery cells from among the stack in front of the cell spacer, and the second sub-module comprises the battery cells from among the stack behind the cell spacer.

10. The battery module as claimed in claim 1, wherein the battery cells are each thermally connected to a module cooling plate.

11. The battery module as claimed in claim 1, further comprising:
a module venting plate at the lower side of the battery cells; and
a module cooling plate at the upper side of the battery cells;
wherein each of the battery cells abuts, at the lower side, against the module venting plate, and
wherein the module cooling plate is thermally connected to the upper side of each of the battery cells.

12. A vehicle comprising the battery module as claimed in claim 1.

13. A battery pack comprising the battery module as claimed in claim 1.

14. A vehicle comprising the battery pack as claimed in claim 13.

15. A method for assembling a battery module, the battery module comprising: a first beam having a plurality of first openings; a second beam having a plurality of second openings; a plurality of first busbars, a plurality of second busbars, and a plurality of battery cells, each of the battery cells comprising a hardcase having a parallelepiped shape with a pair of main sides arranged opposite to each other, a first terminal side and a second terminal side arranged opposite to each other, and a lower side and an upper side arranged opposite to each other, each of the battery cell further comprising a first terminal arranged on the first terminal side and a second terminal arranged on the second terminal side, the method comprising:
arranging the battery cells into a stack aligned in a stack direction such that the main sides of each of the battery cells are arranged perpendicular to the stack direction;
attaching the first busbars to the first beam, and attaching the second busbars to the second beam;
arranging the first beam along the stack such that each of the first terminal sides faces the first beam, the first beam being oriented such that the first busbars are each positioned between the first beam and the stack;
arranging the second beam along the stack such that each of the second terminal sides faces the second beam, the second beam being oriented such that the second busbars are each positioned between the second beam and the stack;
moving the first beam toward the stack such that the first busbars abut against the first terminals located in an area of the first busbars and connecting the first busbars to the first terminals located in an area of the first busbars, the connecting being performed to the first busbars via respective ones of the first openings; and
moving the second beam toward the stack such that the second busbars abut against the second terminals located in an area of the second busbars and connecting the second busbars to the second terminals located in an area of the second busbars, the connecting being performed to the second busbars via respective ones of the second openings.

16. The method as claimed in claim 15, further comprising:
arranging a first end-plate in front of a first one of the battery cells when viewing into the stack direction, and arranging a second end-plate behind a last one of the battery cells when viewing into the stack direction;
pre-compressing the assembly of the battery cells and the first and second end-plates in the stack direction;
further compressing the assembly of the battery cells and the first and second end-plates in the stack direction such that each of the first and second end-plates contacts the first and the second beam; and
fixing each of the first and second end-plate to each of the first and second beam.
